(19) United States
(12) Patent Application Publication
(10) Pub. No.: US 2026/0336284 A1
(43) Pub. Date: Oct. 29, 2026

(54) RECORDING ELEMENT SUBSTRATE

(71) Applicant: CANON KABUSHIKI KAISHA, Tokyo (JP)

(72) Inventors: SUGURU TANIGUCHI, Kanagawa (JP); KENJI FUKADA, Tokyo (JP); TOSHIO NEGISHI, Kanagawa (JP)

(21) Appl. No.: 19/573,367

(22) Filed: Mar. 20, 2026

(30) Foreign Application Priority Data
Apr. 23, 2025 (JP) 2025-071748

(51) Int. Cl. B41J 2/14; B41J 2/045; B41J 2/175

(52) U.S. Cl. CPC B41J 2/14072; B41J 2/04548; B41J 2/0458; B41J 2/175; B41J 2002/14491; B41J 2202/12

(57) ABSTRACT

A recording element substrate includes: a resistive heating element region being arranged, a second resistive heating element row being parallel to a first resistive heating element row; a second driving element row being parallel to a first driving element row, a driving element region being located in parallel to the resistive heating element region; a first wiring layer connecting farther one of the first driving element row and the second driving element row from the resistive heating element region and closer one of the first resistive heating element row and the second resistive heating element row from the driving element region; and a second wiring layer connecting closer one of the first driving element row and the second driving element row and farther one of the first resistive heating element row and the second resistive heating element row.

### BACKGROUND

### Field of the Technology

The present disclosure relates to a technique for arranging driving elements on a recording element substrate.

### Field of the Technology

Conventionally, there have been known circulation-type liquid ejecting apparatuses that circulate ink in the liquid ejecting head. As a circulation-type liquid ejecting apparatus, Japanese Patent Laid-Open No. 2020-104493 (hereinafter referred to as Literature 1) discloses a configuration in which ejection energy generating elements for ejecting ink and circulation energy generating elements for circulating ink are provided. Further, a driving element is used to drive each of an ejection energy generating element and a circulation energy generating element.

Literature 1 discloses a configuration in which a row of ejection energy generating elements and a row of circulation energy generating elements are arranged in parallel. Thus, although a driving element is provided for each of an ejection energy generating element and a circulation energy generating element on a recording element substrate, there have been cases where the driving elements cannot be properly arranged on the recording element substrate.

### SUMMARY

A recording element substrate according to an aspect of the present disclosure comprises: a resistive heating element region including a first resistive heating element row including a plurality of first resistive heating elements being arranged in a row and a second resistive heating element row including a plurality of second resistive heating elements being arranged in a row, the second resistive heating element row being parallel to the first resistive heating element row; a driving element region including a first driving element row including a plurality of first driving elements for driving the plurality of first resistive heating elements, the plurality of first driving elements being arranged in a row, and a second driving element row including a plurality of second driving elements being arranged in a row, the second driving element row being parallel to the first driving element row, the driving element region being located in parallel to the resistive heating element region; a first wiring layer connecting farther one of the first driving element row and the second driving element row from the resistive heating element region and closer one of the first resistive heating element row and the second resistive heating element row from the driving element region; and a second wiring layer connecting closer one of the first driving element row and the second driving element row from the resistive heating element region and farther one of the first resistive heating element row and the second resistive heating element row from the driving element region, wherein the first wiring layer is formed in a layer different from the second wiring layer.

Features of the present disclosure will become apparent from the following description of embodiments with reference to the attached drawings. The following description of embodiments is described by way of example.

### BRIEF DESCRIPTION OF THE DRAWINGS

FIG. 1A is a perspective view schematically showing a liquid ejecting apparatus in which ink tanks as liquid reservoirs are provided outside a liquid ejecting head;

FIG. 1B is a perspective view schematically showing a liquid ejecting apparatus in which ink sub-tanks are provided directly above a liquid ejecting head;

FIG. 2A is an exploded perspective view of the liquid ejecting head 1 in FIG. 1;

FIG. 2B is a diagram showing a case where the number of colors that can be ejected with one liquid ejecting chip is four;

FIG. 2C is a diagram showing a case where the number of colors that can be ejected with one liquid ejecting chip is two;

FIG. 2D is a diagram showing a case where the number of colors that can be ejected with one liquid ejecting chip is one;

FIG. 3A is a plan view of an individual ejection unit seen from the direction in which droplets are ejected from ejection ports;

FIG. 3B is a cross-sectional view taken along IIIB-IIIB in FIG. 3A;

FIG. 3C is a cross-sectional view taken along IIIB-IIIB in FIG. 3A in which the configuration in the recording element substrate is different from that in FIG. 3B;

FIG. 3D is a diagram illustrating the inflow of ink when a first ejection heater or a second ejection heater is driven;

FIG. 4A is a cross-sectional view of the individual ejection unit in FIG. 3A taken along IIIB-IIIB, which is for illustrating the generation and growth process of a bubble generated by the film boiling of ink when the ink is heated by the second ejection heater;

FIG. 4B is a cross-sectional view of the individual ejection unit in FIG. 3A taken along IIIB-IIIB, which is for illustrating the shrinkage process of the bubble generated by the film boiling of the ink when the ink is heated by the second ejection heater;

FIG. 4C is a cross-sectional view of the individual ejection unit in FIG. 3A taken along IIIB-IIIB, which is for illustrating the post-defoaming process of the bubble generated by the film boiling of the ink when the ink is heated by the second ejection heater;

FIG. 5A is a diagram showing the state in which the circulatory ink flow is temporarily paused;

FIG. 5B is a diagram showing the state immediately after a circulatory ink flow is generated by driving the second ejection heater after the state in FIG. 5A;

FIG. 5C is a diagram showing the state in which the circulatory ink flow is temporarily paused after the state in FIG. 5B;

FIG. 5D is a diagram showing the state immediately after a circulatory ink flow is generated by driving the second ejection heater after the state in FIG. 5C;

FIG. 6A is a diagram showing the state in which the circulatory ink flow is temporarily paused;

FIG. 6B is a diagram showing the state immediately after a circulatory ink flow is generated by driving the second ejection heater after the state in FIG. 6A;

FIG. 6C is a diagram showing the state in which the circulatory ink flow is temporarily paused after the state in FIG. 6B;

FIG. 6D is a diagram showing the state immediately after a circulatory ink flow is generated by driving the second ejection heater after the state in FIG. 6C;

FIG. 7A is a plan view seen from the direction in which droplets are ejected from ejection ports;

FIG. 7B is a cross-sectional view taken along VIIB-VIIB in FIG. 7A;

FIG. 7C is an enlarged schematic diagram of the individual flow channel in FIG. 7A;

FIG. 8A is a plan view seen from the direction in which droplets are ejected from ejection ports;

FIG. 8B is a cross-sectional view taken along VIIIB-VIIIB in FIG. 8A;

FIG. 8C is a cross-sectional view taken along VIIIB-VIIIB in FIG. 8A in which the configuration in the recording element substrate 18 is different from that in FIG. 8B;

FIG. 9A is a plan view seen from the direction in which droplets are ejected from ejection ports;

FIG. 9B is a cross-sectional view taken along IXB-IXB in FIG. 9A;

FIG. 9C is a cross-sectional view taken along IXB-IXB in FIG. 9A in which the configuration in the recording element substrate is different from that in FIG. 9B;

FIG. 10 is a diagram showing an example of a circuit configuration of the recording element substrate according to this embodiment;

FIG. 11A is a functional block diagram of a circuit configuration of a control data supply circuit;

FIG. 11B is a diagram showing an example of a circuit configuration of a second ejection group selection circuit in FIG. 11A;

FIG. 12 is a diagram showing an example of arrangement of heaters and driving elements in a first case according to this embodiment;

FIG. 13 is a partially enlarged view of an example of arrangement of heaters and driving elements in the first case in FIG. 12;

FIG. 14 is a diagram showing a cross-sectional structure taken along the XIIIB-XIIIB line in FIG. 13;

FIG. 15 is a diagram showing a comparative example of arrangement of heaters and driving elements;

FIG. 16 is an example of arrangement of heaters and driving elements in a second case according to this embodiment;

FIG. 17A is a plan view seen from the direction in which droplets are ejected from ejection ports; and

FIG. 17B is a cross-sectional view taken along the XVIIB-XBIIB line in FIG. 17A.

### DESCRIPTION OF THE EMBODIMENTS

The following will describe preferred embodiments of the present disclosure in detail with reference to the accompanying drawings. Note that the following embodiments do not limit the matters of the present disclosure, and not all of the combinations of features described in the following embodiments are required for the solutions of the present disclosure. Note that the same constituent elements will be given the same reference numeral.

### Overview

Conventionally, for example, an inkjet recording head that ejects ink (also referred to as liquid) has been known as a liquid ejecting head. The inkjet recording head includes an ejection port that ejects ink. Volatile components in the ink may evaporate from this ejection port. Thus, the evaporation of volatile components in the ink may thicken the ink in the ejection port. Such thickening of the ink changes the ink ejection speed. If the ink ejection speed changes, it is also assumed that the ink landing accuracy is not as intended. In other words, a decrease in the ink landing accuracy may cause ejection failure. In particular, in cases where the pause time of the ink ejecting operation is long, the increase in ink viscosity may be significant. If the increase in ink viscosity is significant, it is also assumed that the solid content in the ink sticks to the inside of ejection ports. Under such an assumption, the flow resistance of the ink increases. Thus, ink ejection failure may occur more easily.

One known countermeasure to the liquid thickening phenomenon as described above is to cause refreshing liquid to flow to the ejection port. To cause the liquid to flow, for example, there is a way to use a pump or the like as a configuration provided on the main body side, in addition to the constituent elements for ejection. Using this pump can generate a pressure difference in the liquid in the inkjet recording head. This pressure difference may circulate the liquid. Alternatively, there is a way to provide a circulation element in the constituent elements for ejection themselves. If a resistive heating element is used as a circulating element, the resistive heating element can foam the liquid. This foaming may circulate the liquid.

Incidentally, there has been disclosed a technique that allows desired liquid ejection from ejection ports after the state where liquid is not ejected from ejection ports continues for a long time using ejection heaters for ink ejection operations and circulation heaters for ink circulation operations. In this technique, a plurality of ejection heaters (also referred to as first resistive heating elements) and a plurality of circulation heaters (also referred to as second resistive heating elements) are each arranged in a row, and the rows are arranged in parallel.

To drive the ejection heaters and the circulation heaters, it is assumed to dispose a power supply, drivers (also referred to as driving elements), and drain wires to connect the drivers to the ejection heaters and the circulation heaters. The drivers that drive the ejection heaters and the drivers that drive the circulation heaters may be placed on one side in consideration of other circuits. In the above technique, a plurality of supply ports for supplying ink are arranged in a row. The plurality of supply ports arranged in a row are used in common. Further, as a supply port for supplying ink, one independent supply port may be provided for each segment unit that is based on the number of heaters such as ejection heaters and circulation heaters. If an independent supply port is used, the drivers and the heaters are placed to sandwich the independent supply port. Thus, it is sufficient that the drain wires are laid out to pass between independent supply ports.

However, in recent years, the number of ejection ports has been increasing in order to achieve printing with higher resolution. As the number of ejection ports increases, the amount of supplied ink also increases. It is envisaged to increase the size of independent supply ports in order to accommodate the increase in the amount of supplied ink. However, the available region on the recording element substrate is limited. Thus, if the size of independent supply ports is increased, the region between independent supply ports narrows. If the region between independent supply ports narrows, the region available for passing the drain wires decreases.

Further, when the circulation heaters are provided on the recording element substrate, the number of drain wires and the number of drivers increase compared to a recording element substrate equipped with no circulation heaters. For example, when the same number of circulation heaters and ejection heaters are disposed, it is assumed that the number of drain wires and the number of drivers are doubled. Under such an assumption, the total number of drain wires increases. Thus, in the case of a layout in which all the drain wires including the increased number of wires pass through the region between independent supply ports, it may not be possible to secure the wire width of each drain wire as intended.

Further, it is also assumed that circulation heaters cannot be provided in the above technique. Under this assumption, all heaters provided on the recording element substrate are ejection heaters. If all heaters are ejection heaters, the resistance values of the drain wires connecting the drivers and the ejection heaters can be equalized to reduce the variations in heat generated in each drain wire. If such variations can be reduced, it is possible to stably drive the ejection heaters.

In the present disclosure, a recording element substrate includes a resistive heating element region, a driving element region, a first wiring layer, and a second wiring layer. The resistive heating element region includes a first resistive heating element row in which a plurality of first resistive heating elements are arranged in a row and a second resistive heating element row which is arranged in parallel to the first resistive heating element row and in which a plurality of second resistive heating elements are arranged in a row. The driving element region is located in parallel to the resistive heating element region. The driving element region includes a first driving element row in which a plurality of first driving elements for driving the plurality of first resistive heating elements are arranged in a row and a second driving element row which is arranged in parallel to the first driving element row and in which a plurality of second driving elements are arranged in a row. The first wiring layer connects one of the first driving element row and the second driving element row that is farther from the resistive heating element region to one of the first resistive heating element row and the second resistive heating element row that is closer to the driving element region. The second wiring layer connects one of the first driving element row and the second driving element row that is closer to the resistive heating element region to one of the first resistive heating element row and the second resistive heating element row that is farther from the driving element region. The first wiring layer is a layer formed in a layer different from the second wiring layer. Such a configuration makes it easier to uniformize the respective wire lengths of wires included in the first wiring layer and wires included in the second wiring layer. Thus, it becomes easy to equalize the respective wire resistance values of the wires included in the first wiring layer and the wires included in the second wiring layer. Therefore, it is possible to equalize the respective energy losses (hereinafter referred to as voltage drops) that occur in the first wiring layer and the second wiring layer. In other words, the driving elements can be properly arranged on the recording element substrate.

Further, the present disclosure can make the wire width of the drain wires as intended, ensure the size of the drivers, and reduce the energy consumed by the drain wires of the ejection heaters to efficiently drive the heaters. In other words, the driving elements can be properly arranged on the recording element substrate.

Further, according to the present disclosure, the first wiring layer and the second wiring layer are formed in different layers. Thus, laying out the drain wires in two layers doubles the region where the drain wires can be passed between independent supply ports. Further, the wire width of the drain wires is set as intended, and the drivers are arranged in two rows, thereby doubling the region where the drivers can be placed. This can ensure sufficient space for placing drivers. Therefore, the size of the drivers can be set as intended.

The following will specifically describe the present disclosure using drawings.
<Liquid Ejecting Apparatus 50>

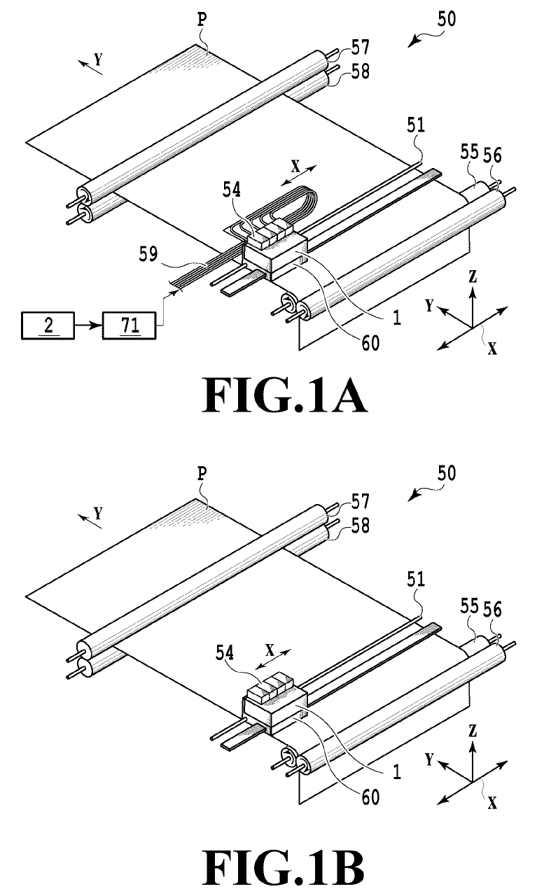

FIG. 1A is a perspective view schematically showing a liquid ejecting apparatus 50 in which ink tanks 2 as liquid reservoirs are provided outside a liquid ejecting head 1. FIG. 1B is a perspective view schematically showing a liquid ejecting apparatus 50 in which ink sub-tanks 54 are provided directly above a liquid ejecting head 1. First, the common parts between FIG. 1A and FIG. 1B will be described.

The liquid ejecting apparatus 50 includes the liquid ejecting head 1 and feed rollers 55, 56, 57, and 58. The liquid ejecting head 1 can perform scanning in a direction X intersecting a feed direction Y of an ejection target medium P. The liquid ejecting head 1 is mounted on a carriage 60. The liquid ejecting head 1 is fixedly supported by the carriage 60 with unillustrated positioning means and electrical contacts provided on the carriage 60. The carriage 60 reciprocally moves in a main scanning direction (also referred to as the direction X) along a guide shaft 51. Thus, the liquid ejecting head 1 performs recording on the ejection target medium P by ejecting ink while moving in the main scanning direction together with the carriage 60. The feed rollers 55, 56, 57, and 58 feed the ejection target medium P in a sub-scanning direction (also referred to as the feed direction Y) intersecting (in this embodiment, orthogonal to) the main scanning direction. In other words, the liquid ejecting apparatus 50 constitutes a serial-type inkjet liquid ejecting apparatus by ejecting liquid from the liquid ejecting head 1 on the ejection target medium P being fed in the feed direction Y while causing the liquid ejecting head 1 to perform scanning in the direction X. Note that the application of the present disclosure is not limited to serial-type inkjet liquid ejecting apparatuses. The present disclosure is also applicable to page-wide type inkjet liquid ejecting apparatuses that eject liquid onto the ejection target medium P being fed in the feed direction Y by using a line head (a page-wide type head) that is long in the page width direction of the ejection target medium P. Note that in FIG. 1A and FIG. 1B, the direction Z indicates the vertical direction. In other words, the direction Z is the direction intersecting (in this embodiment, orthogonal to) the X-Y plane identified by the direction X and the feed direction Y.

The liquid ejecting head 1 can eject four types of inks: black (K), cyan (C), magenta (M), and yellow (Y). The liquid ejecting head 1 can record full-color images with these four types of inks. Note that the inks that can be ejected from the liquid ejecting head 1 are not limited to the above four types of inks. The present disclosure is also applicable to liquid ejecting heads 1 for ejecting other types of inks, such as special color inks. In other words, the types and number of inks ejected from the liquid ejecting head 1 are not limited.

Next, the different parts between FIG. 1A and FIG. 1B will be described. In FIG. 1A, the ink sub-tanks 54 are mounted on the liquid ejecting head 1. Four ink supply tubes (liquid communication paths) 59 are attached to the ink sub-tanks 54. Further, the liquid ejecting apparatus 50 includes the ink tanks 2 and external pumps 71. The ink tanks 2 reserve inks. The inks reserved in the ink tanks 2 are supplied to the ink sub-tanks 54 through the four ink supply tubes 59 by the driving force of the external pumps 71. On the other hand, in FIG. 1B, the ink sub-tanks 54 are provided directly above the liquid ejecting head 1. FIG. 1B is different from FIG. 1A in that since the ink tanks 2 are not provided outside the liquid ejecting head 1, the four ink supply tubes 59 are not attached, and the external pumps 71 are not provided. Note that in both FIG. 1A and FIG. 1B, the liquid ejecting head 1 may be provided integrally with the ink sub-tanks 54 and configured to be detachable from or attachable to the carriage 60. Alternatively, the ink sub-tanks 54 may be integrated with the carriage 60, and only the ink sub-tanks 54 may be configured to be detachable or attachable. The following will provide a description while using the configuration in FIG. 1A.
<Basic Configuration of Liquid Ejecting Head 1>

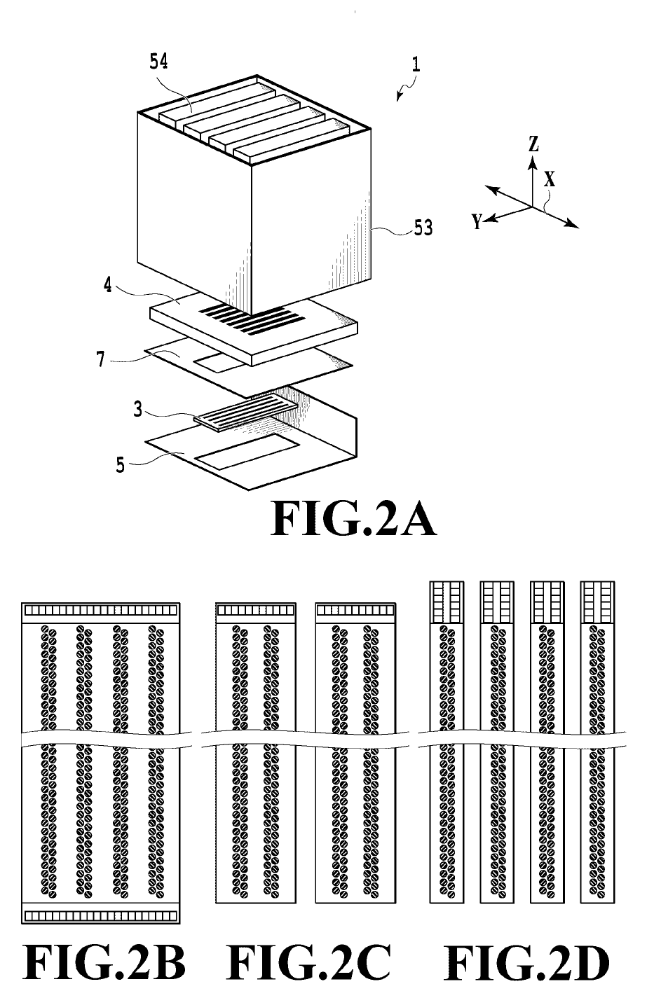

FIG. 2A is an exploded perspective view of the liquid ejecting head 1 in FIG. 1. FIG. 2B, FIG. 2C, and FIG. 2D are diagrams showing examples of a liquid ejecting chip 3 in FIG. 2A. The liquid ejecting head 1 includes a container portion 53, the ink sub-tanks 54, and the liquid ejecting chip 3. The ink sub-tanks 54 temporarily reserve ink in the liquid ejecting head 1. The ink sub-tanks 54 are contained in the container portion 53. Although details will be described later, the liquid ejecting chip 3 is provided at the bottom of the container portion 53. The liquid ejecting chip 3 ejects ink supplied from the ink sub-tanks 54 onto the ejection target medium P.

Note that although not shown, liquid connector insertion ports are provided on a wall of the container portion 53. Liquid connectors provided at the tips of the ink supply tubes 59 in FIG. 1A are inserted into these liquid connector insertion ports and thus liquid-tightly connected thereto. This configuration forms ink supply paths from the ink tanks 2 through the external pumps 71 to the liquid ejecting head 1. This means that the ink in the liquid ejecting head 1 may be circulated by the driving force of the external pumps 71. In this embodiment, four types of inks are used. Thus, four sets of an ink tank 2, an external pump 71, an ink supply tube 59, and an ink sub-tank 54 are provided for the respective inks. Therefore, four ink supply channels corresponding to the respective inks are formed independently. Thus, in this embodiment, the liquid ejecting apparatus 50 includes an ink supply system in which ink is supplied from the ink tanks 2 provided outside the liquid ejecting head 1.

A first support member 4 and a second support member 7 are provided between the container portion 53 and the liquid ejecting chip 3. An electrical wiring member 5 is provided below the liquid ejecting chip 3. Specifically, the first support member 4 is provided with ink supply ports and ink collecting ports. The second support member 7 is provided with an opening. The liquid ejecting chip 3 is fixed to the first support member 4 by bonding. The first support member 4 is fixed to the second support member 7 by bonding. The second support member 7 holds the electrical wiring member 5 so that it is electrically connected to the liquid ejecting chip 3. The electrical wiring member 5 applies an electrical signal for ejecting ink or an electrical signal to circulating ink to the liquid ejecting chip 3.

Note that in this embodiment, the liquid ejecting apparatus 50 does not include an ink collecting system such that ink in the liquid ejecting head 1 is collected to the ink tanks 2. Thus, although the liquid ejecting head 1 is provided with liquid connector insertion ports for connecting the liquid connectors of the ink supply tubes 59, it is not provided with connector insertion ports for connecting tubes for collecting ink to the ink tanks 2.

FIG. 2B shows a case where the liquid ejecting chip 3 is composed of one chip per four colors. In other words, FIG. 2B shows a case where the number of colors that can be ejected by one liquid ejecting chip 3 is four. The liquid ejecting chip 3 includes a plurality of ejection ports and pads used for electrical mounting. The four colors are, for example, black, cyan, magenta, and yellow, and rows are separated by color. The rows are formed in the feed direction Y and spaced in the direction X. Each row includes a plurality of ejection ports. The plurality of ejection ports are evenly spaced in the Y direction. The respective ejection ports of the rows may not be spaced in the X direction, but may be arranged in a single row in the Y direction. Alternatively, only black may be arranged in two rows, the other three colors may be arranged in three rows, so the four colors may be arranged in a total of five rows. Note that the liquid ejecting chip 3 in FIG. 2A shows an example of configuration of one chip per four colors. In other words, the liquid ejecting chip 3 in FIG. 2A shows an example of the case in FIG. 2B.

FIG. 2C shows a case where the liquid ejecting chip 3 is composed of one chip per two colors. In this case, two chips are used. In other words, FIG. 2C shows a case where the number of colors that can be ejected by one liquid ejecting chip 3 is two. When the liquid ejecting chips 3 are mounted on the liquid ejecting head 1, two liquid ejecting chips 3 may be mounted on one liquid ejecting head 1, or two liquid ejecting heads 1 on each of which one liquid ejecting chip 3 is mounted may be prepared.

FIG. 2D shows a case where the liquid ejecting chip 3 is composed of one chip per color. In this case, four chips are used. In other words, FIG. 2D shows a case where the number of colors that can be ejected by one liquid ejecting chip 3 is one. When the liquid ejecting chips 3 are mounted on the liquid ejecting head 1, four liquid ejecting chips 3 may be mounted on one liquid ejecting head 1, or four liquid ejecting heads 1 on each of which one liquid ejecting chip 3 is mounted may be prepared.

Note that when it is assumed that a plurality of liquid ejecting chips 3 are mounted on one liquid ejecting head 1 as shown in FIG. 2C and FIG. 2D, the chip lengths of the liquid ejecting chips 3 may not be the same. Further, the number of colors of the liquid ejecting chips 3 is not particularly limited, and various numbers of colors can be combined. For example, although FIG. 2A shows an example in which the number of colors of the liquid ejecting chip 3 is four, the number of colors of the liquid ejecting chip 3 may be more than four.
<Individual Flow Channel; Straight Type>

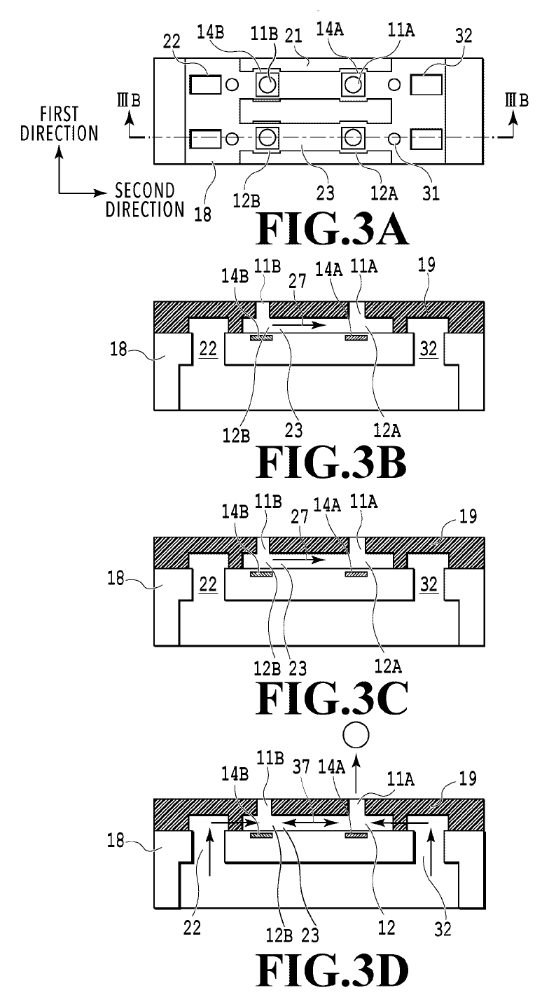

The liquid ejecting head 1 includes a plurality of individual ejection units each including an individual flow channel. The liquid ejecting head 1 also includes a supply flow channel for supplying liquid to the individual flow channel of each individual ejection unit. FIG. 3A is a plan view of an individual ejection unit seen from the direction in which droplets are ejected from ejection ports 11. FIG. 3B is a cross-sectional view taken along IIIB-IIIB in FIG. 3A. FIG. 3C is a cross-sectional view taken along IIIB-IIIB in FIG. 3A in which the configuration in the recording element substrate 18 is different from that in FIG. 3B.

An individual ejection unit includes ejection ports 11A and 11B, pressure chambers 12A and 12B, a first ejection heater RhA, and a second ejection heater RhB. When the ejection port 11A and the ejection port 11B are not distinguished, they are referred to as the ejection port 11. A flow channel that communicates between the pressure chamber 12A and the pressure chamber 12B is formed. When the pressure chamber 12A and the pressure chamber 12B are collectively referred to, they are referred to as the pressure chamber 12.

A pressure chamber 12 is formed corresponding to each ejection port 11 by separating the space between the recording element substrate 18 and an orifice plate 19 with partitions 21. The ejection port 11 is an opening formed in a part of the orifice plate 19. A meniscus of ink having flowed through the pressure chamber 12 is formed in the ejection port 11, and an ejection port interface is formed as an interface between the ink and the atmosphere. The ejection port 11 ejects liquid.

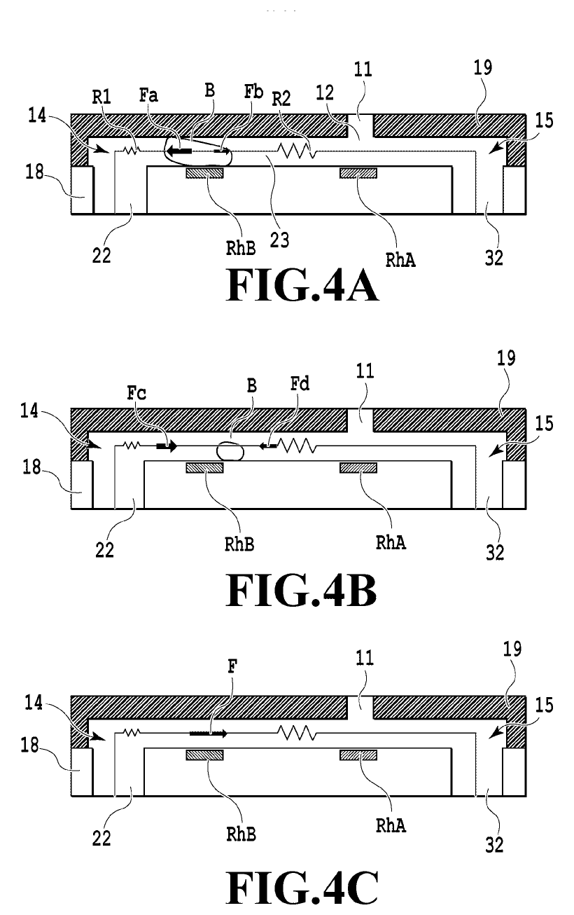

An individual flow channel 23 is extended in a second direction intersecting the direction (first direction) in which ejection ports 11 are arranged in a row. The individual flow channel 23 includes the pressure chambers 12, a supply flow channel 14 (described later in FIG. 4) and an outflow channel 15 (described later in FIG. 4). The supply flow channel 14 communicates with the pressure chamber 12B. The outflow channel 15 communicates with the pressure chamber 12A.

A supply port 22 is provided on one end side of the individual flow channel 23. The supply port 22 is an opening that passes through the recording element substrate 18 from an unillustrated common flow channel to the upstream side of the individual flow channel 23. A supply port 32 is provided on the other end side of the individual flow channel 23. The supply port 32 is an opening that passes through the recording element substrate 18 from the unillustrated common flow channel to the downstream side of the individual flow channel 23. Liquid is supplied to the individual flow channel 23 through the supply port 22 and the supply port 32.

On the recording element substrate 18, a first ejection heater RhA is formed closer to the supply port 32 than the supply port 22. The first ejection heater RhA is an element that generates energy for ejecting liquid in the pressure chamber 12A from the ejection port 11A. Specifically, the first ejection heater RhA foams the liquid (also referred to as ink) in the pressure chamber 12A by thermal driving, thereby enabling ejection of ink from the ejection port 11A by utilizing the bubble generating energy. Although the first ejection heater RhA uses an electrothermal conversion element in this embodiment, it is not particularly limited. For example, the first ejection heater RhA may use a piezo element.

In the recording element substrate 18, a second ejection heater RhB is formed closer to the supply port 22 than the supply port 32. The second ejection heater RhB is an element that generates energy for ejecting liquid in the pressure chamber 12B from the ejection port 11B. Specifically, the second ejection heater RhB foams the liquid (also referred to as ink) in the pressure chamber 12B by thermal driving, thereby enabling ejection of ink from the ejection port 11B by utilizing the bubble generating energy. Although the second ejection heater RhB uses an electrothermal conversion element in this embodiment, it is not particularly limited. For example, the second ejection heater RhB may use a piezo element.

Note that as shown in an example in FIG. 4 described later, when the ejection port 11B is not provided above the second ejection heater RhB, it is assumed that the second ejection heater RhB has the following functions. In other words, it is assumed that the second ejection heater RhB is an element that generates energy for generating a circulatory ink flow in the individual flow channel 23 in the direction indicated by an arrow 27.

Now, a straight type will be described. The straight type means that the shape of the individual flow channel 23 is configured so that both ends of the individual flow channel 23 are located to sandwich the ejection ports 11 and the direction passing through both ends of the individual flow channel 23 extends in the second direction intersecting the first direction. Put differently, in the individual flow channel 23, the first ejection heater RhA is arranged in the second direction intersecting the first direction along the row of ejection ports 11A. Similarly, the second ejection heater RhB is arranged in the second direction intersecting the first direction along the row of ejection ports 11B.

Further, the supply flow channel 14 is formed on the second ejection heater RhB side (see FIG. 4). The supply flow channel 14 is composed of one part of the individual flow channel 23 on the second ejection heater RhB side and the supply port 22. On the other hand, the outflow channel 15 is formed on the first ejection heater RhA side (see FIG. 4). The outflow channel 15 is composed of the other part of the individual flow channel 23 on the first ejection heater RhA side and the supply port 32.

Next, the flow of ink flowing through the individual flow channel 23 will be described. The flow of ink flowing through the individual flow channel 23 is classified into two types. The first ink flow is a flow for refilling after the liquid ejecting apparatus 50 drives the first ejection heater RhA to eject ink from the ejection port 11A. The second ink flow is a flow for operating the external pump 71 to generate a circulatory flow in the direction of the arrow 27.
<First Ink Flow>

FIG. 3D shows how the liquid ejecting apparatus 50 drives the first ejection heater RhA to eject ink from the ejection port 11. FIG. 3D is a diagram illustrating the inflow of ink when a first ejection heater RhA or a second ejection heater RhB is driven. In an example in FIG. 3D, when the first ejection heater RhA is driven to eject ink from the ejection port 11A, ink is supplied from each of the supply port 22 and the supply port 32. Thus, ink flows into the pressure chamber 12 from both the supply port 22 and the supply port 32.
<Second Ink Flow>

On the other hand, when the liquid ejecting apparatus 50 operates the external pump 71 to generate a circulatory flow, ink flows into the individual flow channel 23 through the supply port 22, and ink flows out from the individual flow channel 23 through the supply port 32. In this embodiment, the liquid ejecting apparatus 50 circulates the ink flowing out from the supply port 32 back to the supply port 22, thereby generating a circulatory ink flow in the individual flow channel 23 in the direction indicated by the arrow 27. FIG. 3B shows an example in which the supply port 22 and the supply port 32 are made common within the liquid ejecting chip 3. On the other hand, FIG. 3C shows an example in which the supply port 22 and the supply port 32 are provided as separate flow channels and the separate flow channels are made common outside the liquid ejecting head 1.

The circulatory ink flow will be further described. Ink contains volatile components such as moisture and solid content. When the liquid ejecting head 1 is used, the ejection of ink from the ejection ports 11 may become unstable due to the evaporation of the volatile components in the ink from the ejection ports 11, the concentration of the solid content in the ink around the ejection port 11 caused by the evaporation of the volatile components in the ink, and the like. Thus, various devices have been employed to prevent the ejection of ink from the ejection ports 11 from becoming unstable.

For example, an unillustrated cap member may be provided at a position that is offset from the feeding path of the ejection target medium P in the X direction. The shape of this cap member is formed in such a shape as to be able to cover the ejection port surface provided with the ejection ports 11 of the liquid ejecting head 1. The cap member can prevent the ejection ports 11 from drying or protect the ejection ports 11 by covering the ejection port surface provided with the ejection ports 11 of the liquid ejecting head 1 when the liquid ejecting head 1 is not performing a recording operation on the ejection target medium P.

Further, an unillustrated ink suction mechanism may be provided. In cases where the cap member and the ink suction mechanism are provided, the cap member is used in conjunction with an ink suction operation from the ejection ports 11. The ink suction operation refreshes the ink around the ejection ports 11. Thus, it is possible to maintain the level of image quality of obtained images.

Further, when the liquid ejecting head 1 is not performing a recording operation on the ejection target medium P, it performs an ejection operation called preliminary ejection (also referred to as pre-ejection). This can discard the concentrated ink. Further, when the liquid ejecting head 1 is performing a recording operation on the ejection target medium P, it may perform an ejection operation called preliminary ejection (also referred to as on-paper preliminary ejection or in-page preliminary ejection). On-paper preliminary ejection or in-page preliminary ejection is an ejection operation in which an inconspicuous amount of ink is ejected at a position on the ejection target medium P where the ink is inconspicuous in terms of image quality. Although these ejection operations greatly contribute to improving image quality, they refresh the ejection ports 11. Thus, some ink is discarded. Therefore, the amount of waste ink may be reduced as much as possible.

For example, the circulatory ink flow generated by circulating ink using the external pump 71 makes it possible to prevent the drying of the ejection ports 11 and the concentration of ink around the ejection ports 11 while reducing the amount of waste ink. From another point of view, the number of preliminary ejections of ink and the number of suctions of ink can be reduced as much as possible. Further, reducing the number of preliminary ejections of ink as much as possible makes it possible to increase the throughput or improve the yield of the entire liquid ejecting apparatus 50.

Note that a filter 31 as shown in FIG. 3A may be provided in the circulatory ink flow channel inside and outside the liquid ejecting head 1 to remove foreign substances contained in the ink. The filter 31 is a protrusion formed by protruding a part of the orifice plate 19 toward the recording element substrate 18. In an example in FIG. 3A to FIG. 3D, filters 31 are provided at a position on one end side and a position on the other end side of the individual flow channel 23. In the circulatory ink flow channel, the one end side of the individual flow channel 23 corresponds to the ink inflow side, and the other end side of the individual flow channel 23 corresponds to the ink outflow side. A filter 31 may be provided at a position between the first ejection heater RhA and the second ejection heater RhB in the individual flow channel 23. In the case where a filter 31 is provided at a position between the first ejection heater RhA and the second ejection heater RhB in the individual flow channel 23, filters 31 do not need to be provided at a position on one end side and a position on the other end side of the individual flow channel 23. Next, the principle of generation of a circulatory ink flow will be described using FIG. 4. Note that FIG. 4 shows an example in which the ejection port 11A is provided only above the first ejection heater RhA.
<Principle of Generation of Circulatory Ink Flow >

In FIG. 4A, FIG. 4B, and FIG. 4C, the illustration of the filters 31 is omitted for ease of description. FIG. 4A is a cross-sectional view of the individual ejection unit in FIG. 3A taken along IIIB-IIIB, which is for illustrating the generation and growth process of a bubble B generated by the film boiling of ink when the ink is heated by the second ejection heater RhB. FIG. 4B is a cross-sectional view of the individual ejection unit in FIG. 3A taken along IIIB-IIIB, which is for illustrating the shrinkage process of the bubble B generated by the film boiling of the ink when the ink is heated by the second ejection heater RhB. FIG. 4C is a cross-sectional view of the individual ejection unit in FIG. 3A taken along IIIB-IIIB, which is for illustrating the post-defoaming process of the bubble B generated by the film boiling of the ink when the ink is heated by the second ejection heater RhB. Next, the generation and growth process, the shrinkage process, and the post-defoaming process of the bubble B will be described.
<Generation and Growth Process of Bubble B>

As shown in FIG. 4A, the second ejection heater RhB is disposed at a position closer to the supply port 22 between the supply port 22 and the supply port 32. Thus, due to generation of the circulatory ink flow, the flow resistance R1 generated in the flow channel between the second ejection heater RhB and the supply port 22 is smaller than the flow resistance R2 generated in the flow channel between the second ejection heater RhB and the supply port 32. Therefore, the bubble B generated by the film boiling of the ink grows leaning toward the flow channel side with the relatively smaller flow resistance R1 due to the difference between the flow resistance R1 and the flow resistance R2, as shown in FIG. 4A. Therefore, a flow vector Fa of ink toward the flow channel on the side where the flow resistance R1 occurs is greater in magnitude than a flow vector Fb of ink toward the flow channel on the side where the flow resistance R2 occurs. Note that the circuit including the flow resistances R1 and R2 is an equivalent circuit in which the flow resistances generated in the flow channel including the individual flow channel 23 due to the circulatory ink flow are expressed by electrical resistances.
<Shrinkage Process of Bubble B>

During the shrinkage process of the bubble B, ink flows in to compensate for the shrunk volume of the bubble B. In this case, as shown in FIG. 4B, a flow vector Fc of ink flowing from the supply port 22 on the flow resistance R1 side is greater in magnitude than a flow vector Fd of ink flowing from the supply port 32 on the flow resistance R2 side. Further, the defoaming position of the bubble B shifts from above the second ejection heater RhB toward the supply port 32 in the flow channel.
<Post-Defoaming Process of Bubble B>

As described using FIG. 4B, there is a relationship of Fc > Fd. Thus, a flow vector F of a circulatory ink flow from the supply port 22 to the supply port 32 is generated. The magnitude of the flow vector F is affected by the ratio of the flow resistances R1 and R2 and the size of the bubble B. For example, assume a case of using the second ejection heater RhB. In this case, the position where the second ejection heater RhB is disposed is preferably closer to one of both ends of the individual flow channel 23 than the position where the first ejection heater RhA is disposed. Specifically, the flow resistance ratio R1/R2 is preferably set in the range of 0.05 to 0.40. Setting the flow resistance ratio R1/R2 in the range of 0.05 to 0.40 can locally maximize the flow vector F of the circulatory ink flow. By increasing the flow vector Fa of ink and increasing the flow vector Fc of ink, the flow vector F of the circulatory ink flow increases and the circulatory ink flow increases. Thus, it is preferable to reduce the flow resistance R1. Further, it is preferable to reduce the flow vector Fb of ink as much as possible and reduce the flow vector Fd of ink. Thus, it is preferable to increase the flow resistance R2. For these reasons, it is preferable to reduce the flow resistance R1 and increase the flow resistance R2. In other words, it is preferable to reduce the flow resistance ratio R1/R2. Further, when the bubble B is large, that is, the volume of the bubble B is large, this increases the excluded volume of fluid in the individual flow channel 23, thus increasing the circulatory flow. Factors that contribute to the increase in the circulation flow include, for example, the following. One factor that contributes to the increase in the circulatory flow is to increase the size of the second ejection heater RhB. Further, another factor that contributes to the increase in the circulatory flow is to widen the width or height of the flow channel on the supply port 22 side to relatively reduce the flow channel resistance R1. In addition, another factor that contributes to the increase in the circulatory flow is to reduce the viscosity of the ink. Furthermore, another factor that contributes to the increase in the circulatory flow is to apply double pulsing to the liquid ejecting head 1. Double pulsing of a drive pulse means the following. First, a pulse that is short enough to avoid generation of a bubble in the flow channel on the second ejection heater RhB is applied to the second ejection heater RhB, thereby warming the ink around the flow channel on the second ejection heater RhB. Subsequently, a main pulse that generates a bubble for circulating ink is applied to the second ejection heater RhB, thereby growing a larger bubble.

Further, a part of ink that flows due to the circulatory ink flow enters the ejection port 11. Thereby, the concentrated ink in the ejection port 11 is sent to the flow channel on the side of the supply port 32, and fresh ink is caused to flow into the ejection port 11 from the flow channel on the side of the supply port 22 through the individual flow channel 23. In this way, it becomes difficult for concentrated ink to stay in the ejection port 11. Thus, it is possible to maintain the initial ink ejection condition while suppressing the effect of concentrated ink.

The circulatory ink flow is a transient flow associated with the growth process and the shrinkage process when the bubble B is generated. Thus, after the bubble B defoams, the inertial circulatory ink flow decays over time and stops after a certain period of time. Therefore, in order to generate a circulatory flow steadily over a certain period of time, it is preferable to repeatedly drive the second ejection heater RhB. Note that the driving cycle of the second ejection heater RhB is not particularly limited as long as the concentrated ink staying in the ejection port 11 can be discharged. However, the circulatory ink flow is a transient flow associated with the growth process and shrinkage process when the bubble B is generated. Thus, in the case of driving at a high driving frequency such as 100 kHz in consideration of the cycle of 10 μs, which is the time from generation to defoaming of the bubble B, a decrease that inhibits the promotion of the circulatory ink flow may also occur. Therefore, for example, it is preferable to drive the second ejection heater RhB at a drive cycle of about 100 Hz to several tens of kHz.

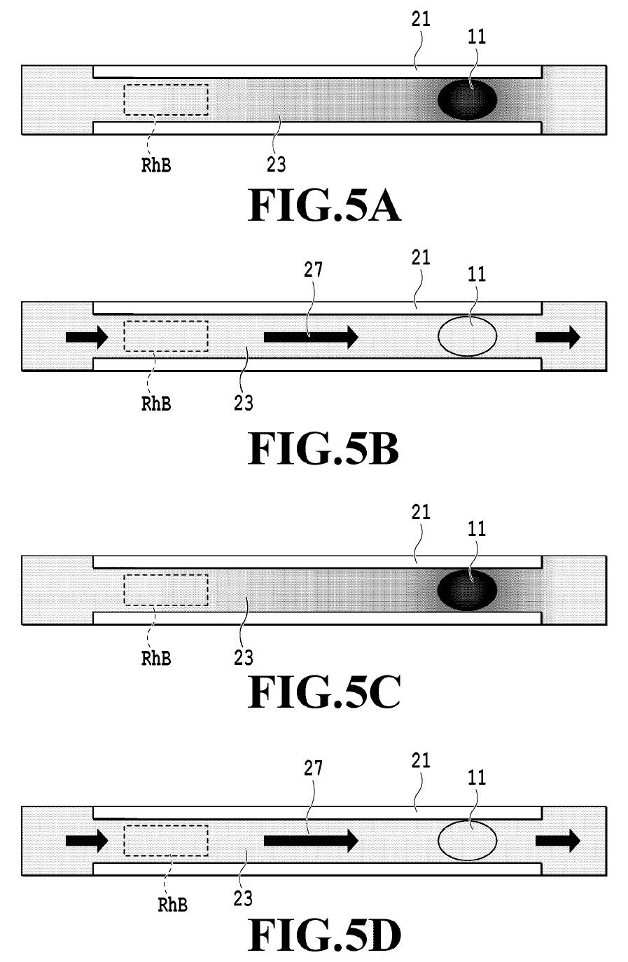

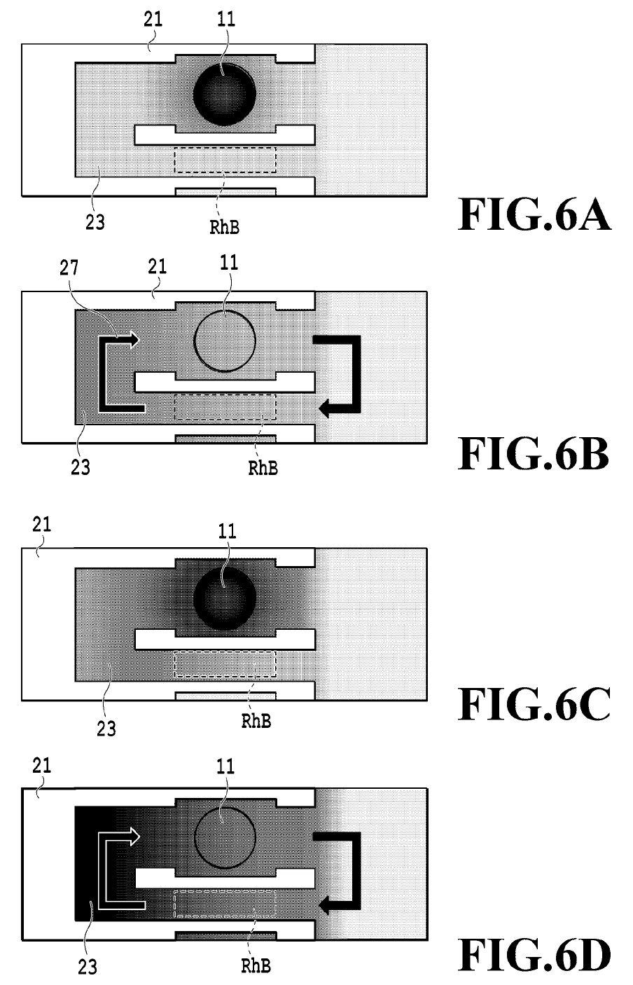

Specifically, the higher the driving frequency of the second ejection heater RhB, the more the circulatory ink flow is maintained, thus increasing the effect of discharging concentrated ink caused by the circulatory ink flow. However, it is also assumed that the higher the driving frequency of the second ejection heater RhB, the higher the temperature of the ink due to the heat generation of the second ejection heater RhB caused by the driving of the second ejection heater RhB. Thus, it is preferable to appropriately control the number of times of driving the second ejection heater RhB. Next, the elimination of ink concentration due to the circulatory ink flow will be described using FIG. 5 and FIG. 6.
<Elimination of Ink Concentration; Straight Type>

FIG. 5A is a diagram showing the state in which the circulatory ink flow is temporarily paused. FIG. 5B is a diagram showing the state immediately after a circulatory ink flow is generated by driving the second ejection heater RhB after the state in FIG. 5A. FIG. 5C is a diagram showing the state in which the circulatory ink flow is temporarily paused after the state in FIG. 5B. FIG. 5D is a diagram showing the state immediately after a circulatory ink flow is generated by driving the second ejection heater RhB after the state in FIG. 5C. As shown in FIGS. 5A-5D , the straight-type individual flow channel 23 has a configuration in which the inlet and outlet of the circulatory ink flow are separated. Note that dotted hatching is applied to the ink in the individual flow channel 23, and the concentration of dotted hatching is increased at a place where the ink is concentrated to express the degree of ink concentration.

As shown in FIG. 5A, when the circulatory ink flow is temporarily paused, volatile components in ink evaporate from the ejection port 11. Thus, ink concentration proceeds in the vicinity of the ejection port 11. Then, when the second ejection heater RhB is driven, the circulatory ink flow resumes. As a result, the ink concentration that has progressed in the vicinity of the ejection port 11 is eliminated, as shown in FIG. 5B. Then, when the circulatory ink flow is temporarily paused, ink concentration proceeds again in the vicinity of the ejection port 11, as in FIG. 5A. Then, when the second ejection heater RhB is driven, the circulatory ink flow resumes. As a result, as shown in FIG. 5D, the ink concentration that has progressed in the vicinity of the ejection port 11 is eliminated, as in FIG. 5B. Thus, the ink concentration is eliminated even in the entire individual flow channel 23. As mentioned above, in the straight-type individual flow channel 23, the concentrated state of ink is reset each time the temporal pause and resumption of the circulatory ink flow are repeated.
<Elimination of Ink Concentration; U-Shaped>

FIG. 6A is a diagram showing the state in which the circulatory ink flow is temporarily paused. FIG. 6B is a diagram showing the state immediately after a circulatory ink flow is generated by driving the second ejection heater RhB after the state in FIG. 6A. FIG. 6C is a diagram showing the state in which the circulatory ink flow is temporarily paused after the state in FIG. 6B. FIG. 6D is a diagram showing the state immediately after a circulatory ink flow is generated by driving the second ejection heater RhB after the state in FIG. 6C. As shown in FIGS. 6A-6D , a U-shaped individual flow channel 23 has a configuration in which the inlet and outlet of the circulatory ink flow are adjacent to each other. Note that dotted hatching is applied to the ink in the individual flow channel 23, and the concentration of dotted hatching is increased at a place where the ink is concentrated to express the degree of ink concentration.

As shown in FIG. 6A, when the circulatory ink flow is temporarily paused, volatile components in ink evaporate from the ejection port 11. Thus, the ink concentration proceeds in the vicinity of the ejection port 11. Then, when the second ejection heater RhB is driven, the circulatory ink flow resumes. This results in the state shown in FIG. 6B. The inlet of the individual flow channel 23 in FIG. 6A is adjacent to the outlet of the individual flow channel 23 in FIG. 6A. Thus, although the ink concentrated in the vicinity of the ejection port 11 is discharged from the outlet of the individual flow channel 23, a part of the discharged ink flows back in from the inlet of the individual flow channel 23. Therefore, the entire individual flow channel 23 is not replaced with fresh ink, but a phenomenon of being replaced with slightly concentrated ink occurs (this phenomenon will hereinafter be referred to as recirculation concentration). Then, when the circulatory ink flow is temporarily paused, as shown in FIG. 6C, ink concentration proceeds again in the vicinity of the ejection port 11 from the state in FIG. 6B, as in FIG. 6A. Then, when the second ejection heater RhB is driven, the circulatory ink flow resumes. As a result, as shown in FIG. 6D, due to the effect of recirculation concentration, the entire individual flow channel 23 is replaced with ink that is concentrated even more than in FIG. 6B. As mentioned above, in the U-shaped individual flow channel 23, the concentrated state of ink is not reset each time the temporal pause and circulation operation of the circulatory ink flow are repeated, and the ink concentration progresses gradually throughout the individual flow channel 23. Thus, the concentrated state of ink deteriorates. Note that even in the case of not repeating the temporal pause and resumption of the circulatory ink flow, the progression of ink concentration in the vicinity of the ejection port 11 due to a long pause period of the circulatory ink flow makes it difficult to obtain the effect of an improved concentrated state of ink even when the circulatory ink flow is resumed for the first time. This is because the effect of improvement of the concentrated state of ink by recirculation concentration is small.

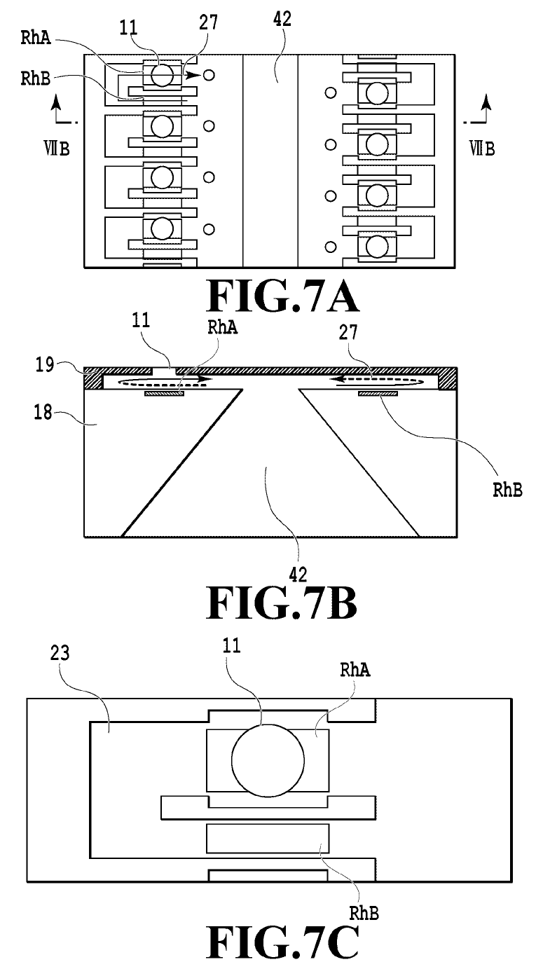

Therefore, the difference in the effect of discharged concentrated ink between the straight-type individual flow channel 23 and the U-shaped individual flow channel 23 causes a difference in the effect of eliminating the concentrated state of ink by temporarily pausing and resuming the circulatory ink flow. Specifically, in the case of the straight-type individual flow channel 23, the concentrated state of ink is easily eliminated, including the entire individual flow channel 23. On the other hand, in the case of the U-shaped individual flow channel 23, it is difficult to eliminate the concentrated state of ink including the entire individual flow channel 23 by recirculation concentration. Thus, in the case of the U-shaped individual flow channel 23, the ink ejection may be unstable depending on the degree of concentration of the entire individual flow channel 23. Next, a configuration in the vicinity of the ejection port 11 of the U-shaped individual flow channel 23 will be described using FIG. 7.
<Configuration in the Vicinity of Ejection Port 11 of U-Shaped Individual Flow Channel 23>

FIG. 7A is a plan view seen from the direction in which droplets are ejected from ejection ports 11. FIG. 7B is a cross-sectional view taken along VIIB-VIIB in FIG. 7A. FIG. 7C is an enlarged schematic diagram of the individual flow channel 23 in FIG. 7A.

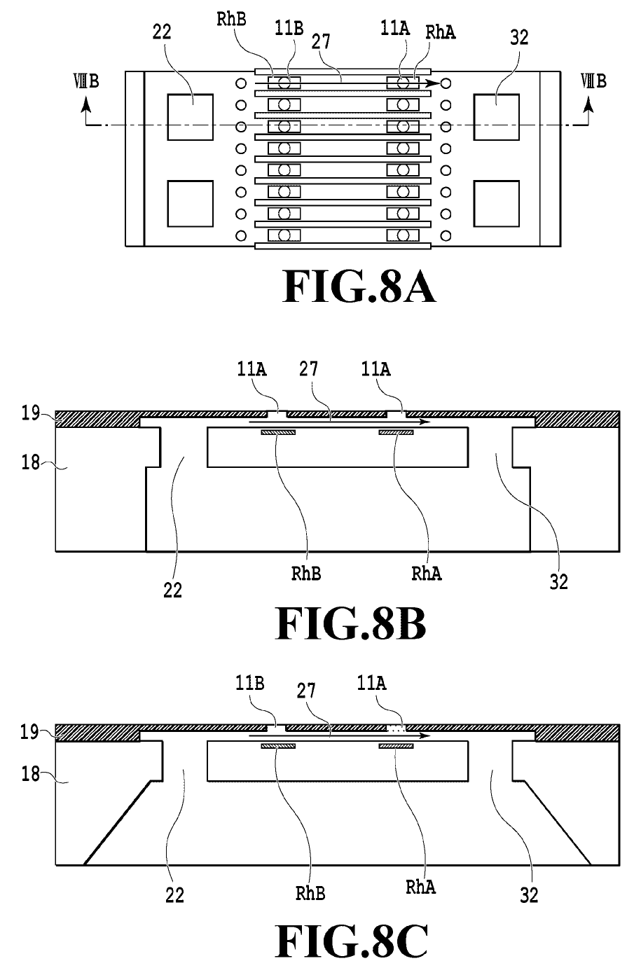

The ejection port 11 in FIG. 7A and FIG. 7B is an opening formed in a part of the orifice plate 19. The first ejection heater RhA is formed on the recording element substrate 18 at a position corresponding to the ejection port 11. The second ejection heater RhB is also formed on the recording element substrate 18. The second ejection heater RhB generates a circulatory ink flow in the flow channel including the individual flow channel 23 in the direction indicated by the arrow 27. A supply groove 42 is formed on the recording element substrate 18 between the row of first ejection heaters RhA and the row of second ejection heaters RhB in the direction along the row of ejection ports 11 so as to penetrate through the recording element substrate 18. The supply groove 42 communicates with the individual flow channel 23 and can supply ink to the individual flow channel 23. In this way, liquid may be caused to flow in and out not only by using a configuration in which a plurality of independent supply openings are provided such as the supply port 22 and the supply port 32 in FIG. 3 but also by using a large opening such as the supply groove 42 in FIG. 7A and FIG. 7B. Next, a configuration in the vicinity of the ejection port 11 of the straight-type individual flow channel 23 will described using FIG. 8A, FIG. 8B, and FIG. 8C.
<Configuration in the Vicinity of Ejection Port 11 of Straight-Type Individual Flow Channel 23>

FIG. 8A is a plan view seen from the direction in which droplets are ejected from ejection ports 11. FIG. 8B is a cross-sectional view taken along VIIIB-VIIIB in FIG. 8A. FIG. 8C is a cross-sectional view taken along VIIIB-VIIIB in FIG. 8A in which the configuration in the recording element substrate 18 is different from that in FIG. 8B. Although FIG. 8B and FIG. 8C show two different example shapes of the rear side of the recording element substrate 18 depending on the type of the etching method on the recording element substrate 18, the shape of the rear side of the recording element substrate 18 may be either shape. In other words, the configuration in the recording element substrate 18 may be any configuration.

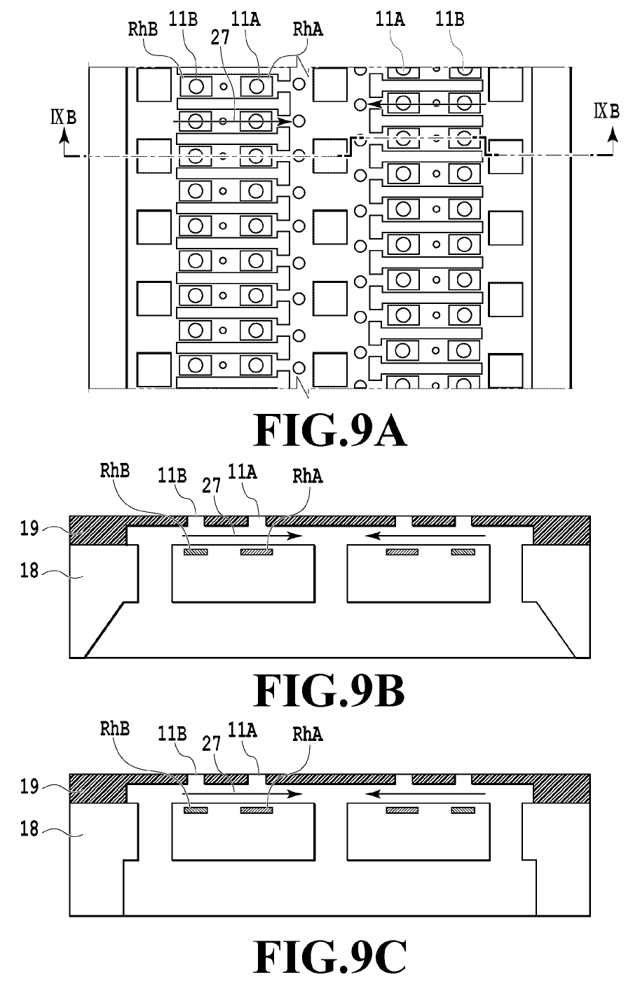

The difference from the configuration in the vicinity of the ejection port 11 of the U-shaped individual flow channel 23 is that it is a straight-type configuration in which the inlet and outlet of the individual flow channel 23 are not adjacent as in the U-shaped individual flow channel 23, but the inlet and outlet of the individual flow channel 23 are separated. Further, the direction that connects both ends of the straight-type individual flow channel 23 is orthogonal to the direction in which the ejection ports 11A and 11B are lined up side by side, as shown in FIG. 8A. With such an arrangement configuration, the position where the circulatory ink flow flows into the individual flow channel 23 is separated from the position where the circulatory ink flow flows out of the individual flow channel 23. Thus, the ink concentrated at the ejection ports 11A and 11B can be prevented from reflowing into the individual flow channel 23. Therefore, the effect of ink concentration can be suppressed. Next, other configurations in the vicinity of the ejection port 11 of the straight-type individual flow channel 23 will be described using FIG. 9A, FIG. 9B, and FIG. 9C.
<Other Configurations in the Vicinity of Ejection Port 11 of Straight-Type Individual Flow Channel 23>

FIG. 9A is a plan view seen from the direction in which droplets are ejected from ejection ports 11. FIG. 9B is a cross-sectional view taken along IXB-IXB in FIG. 9A. FIG. 9C is a cross-sectional view taken along IXB-IXB in FIG. 9A in which the configuration in the recording element substrate 18 is different from that in FIG. 9B. Although FIG. 9B and FIG. 9C show two different example shapes of the rear side of the recording element substrate 18 depending on the type of the etching method on the recording element substrate 18, the shape of the rear side of the recording element substrate 18 may be either shape. In other words, the configuration in the recording element substrate 18 may be any configuration. Further, in FIG. 9B and FIG. 9C, the filters 31 are not shown. Further, the difference from FIG. 8A, FIG. 8B, and FIG. 8C is that the number of rows of ink supply openings is increased by one from two to three. This allows the rows of ejection ports 11A and 11B to be doubled, and the rows of ejection ports 11A can be arranged close to the ink supply openings in the center. In other words, the rows of ejection ports 11A are arranged on both sides of the direction of arrangement of the plurality of ink supply openings in the center, and the rows of ejection ports 11B are also arranged. Such an arrangement can increase the number of rows of ink supply openings by one from two to three, and the number of pairs of ejection ports 11A and 11B can be doubled from one to two. Further, as shown in FIG. 9A, pairs of ejection ports 11A and 11B and other pairs of ejection ports 11A and 11B can be arranged with shifted pitches. Further, it is possible not to include a wiring region between supply openings in the row of ink supply openings in the center. Thus, there is a high degree of freedom in the size and resolution of openings in the row of ink supply openings in the center. This allows for faster refilling in the ejection ports 11A and 11B and dealing with high productivity. Note that the positions of the ejection ports 11A and 11B and the positions of the ink supply openings may be shifted according to the wiring. Next, ink according to this embodiment will be described.
<Ink>

As described above, although the degree of elimination of ink concentration is different based on the difference in the flow channel configuration including the individual flow channel 23, the following effects can be achieved by generating a circulatory ink flow in the individual flow channel 23 using the second ejection heater RhB. In other words, it is possible to suppress the effect of concentrated ink that is thickened by the evaporation of volatile components in ink at the ejection ports 11. Thus, since the ink ejection condition can be maintained well, the effect of changes in the ink ejection speed can be further reduced. Therefore, it is possible to stabilize the ejection of ink.

On the other hand, depending on applications of the liquid ejecting head 1 and the liquid ejecting apparatus 50 equipped with the liquid ejecting head 1, it may be assumed to use inks with different types of ink color materials, different content rates of solid content of ink, or the like. In other words, as for the performance of the liquid ejecting head 1, it is preferable to be able to maintain the ejection stability of ink no matter what kinds of inks are used.

For example, cases caused due to water in ink include cases where changes such as curling (also referred to as warping) and cockling (also referred to as wavy creases) may occur on plain paper sheets. In this case, it is conceivable to use ink with reduced moisture content. Further, ink with low moisture content has a higher concentration of solid content in ink such as organic solvents other than water, pigments, and resins. Thus, as the moisture in ink evaporates, the viscosity of the ink tends to rise rapidly. Therefore, ink with low moisture content tends to reduce ink ejection stability. Therefore, in the case of using ink with low moisture content, it is possible to suppress the increase in ink viscosity by generating a circulatory ink flow in the flow channel configuration including the individual flow channel 23 as in this embodiment. In general, ink with much solid content shows a solid content of 10 wt%. In other words, this embodiment is preferably applied to inks with a solid content rate of 10 wt% (also referred to as mass%) or more in the ink.

The relationship between the operating temperature of the liquid ejecting head 1 and the viscosity of ink will be described. There are cases where the driving of the second ejection heaters RhB arranged throughout the liquid ejecting chip 3 is controlled to increase the temperature of the liquid ejecting head 1 until the temperature of the liquid ejecting head 1 reaches a certain temperature, and then the liquid ejecting head 1 is used. The viscosity of ink changes depending on the temperature of the ink. Thus, the viscosity of ink at the operating temperature of the liquid ejecting head 1 affects the ejection stability of the ink.

The relationship between the circulatory ink flow velocity and the driving frequency of each of the first ejection heater RhA and the second ejection heater RhB will be described. When the second ejection heater RhB generates a circulatory ink flow, it is possible to achieve circulatory flow velocity having an instantaneous ink flow velocity of several 10 mm/s to 1000 mm/s. The average flow velocity over a duration in the order of several 100 μs depends on the driving frequency of the second ejection heater RhB. This is because when the second ejection heater RhB generates a circulatory ink flow, the circulatory ink flow is a transient circulatory flow that decays over time and stops after a certain period of time. On the other hand, when the first ejection heater RhA generates a circulatory ink flow, it can be driven at a frequency of about 10 to 20 kHz, which is about the same as the driving frequency of the first ejection heater RhA (also referred to as the ejection frequency). In this case, the average flow velocity of the circulatory ink flow can be several mm/s to 100 mm/s. Next, the relationship between pigment concentration and elimination of ink concentration will be described.
(Ink with High Pigment Concentration)

A case of ink with high pigment concentration will be described. For example, in the case of using ink at a concentration such that the viscosity of the ink at the operating temperature of the liquid ejecting head 1 is 3-6 cP inclusive, the thickening of the ink in the vicinity of the ejection port 11 is likely to progress according to the non-ejection time of the ink (also referred to as the pause time of the circulatory ink flow). Thus, the ink ejection speed are likely to change. For this reason, the ink ejection stability is likely to deteriorate. To prevent the deterioration in the ink ejection stability, it is preferable to circulate ink by generating a circulatory ink flow while the pause time of the circulatory ink flow is short. Thus, it is preferable to eliminate ink concentration by frequently performing regular ink circulation or transient ink circulation. Therefore, if the second ejection heater RhB is driven, transient ink circulation can be performed. Therefore, it is possible to contribute to the elimination of ink concentration in the vicinity of the ejection port 11 by driving the second ejection heater RhB to frequently resume the circulatory ink flow from the paused state of the circulatory ink flow.
(Ink with Low Pigment Concentration)

A case of ink with low pigment concentration will be described. For example, in the case of using ink at a concentration such that the viscosity of the ink at the operating temperature of the liquid ejecting head 1 is 1-2 cP inclusive, the thickening of the ink in the vicinity of the ejection port 11 may progress depending on the non-ejection time of the ink (also referred to as the pause time of the circulatory ink flow). Thus, although the ink ejection speed may change, the change in the ink ejection speed is relatively small compared to high-concentration ink. On the other hand, when the pause time of the circulatory ink flow is long, for example, the thickening of the ink in the vicinity of the ejection port 11 may progress depending on the non-printing-drive time (also referred to as the stop time). Thus, in the case of restarting after stopping without printing for a certain period of time, it is preferable to carry out a recovery process involving waste ink, such as ink suction operation, wipe operation, and preliminary ejection combined with them. Therefore, if the second ejection heater RhB is driven, it is possible to contribute to the elimination of ink concentration in the vicinity of the ejection port 11 without generating waste ink by resuming the circulatory ink flow as a recovery operation. Further, depending on the stop time, it is possible to avoid waste ink by simply driving the second ejection heater RhB to resume the circulatory ink flow as a recovery operation. Alternatively, it is also possible to reduce waste ink as much as possible by resuming the circulatory ink flow for restoration and also combining the suction operation for removing bubbles B in the liquid ejecting head 1, which is separate from the elimination of ink concentration.
(Configuration More Suitable for Eliminating Ink Concentration)

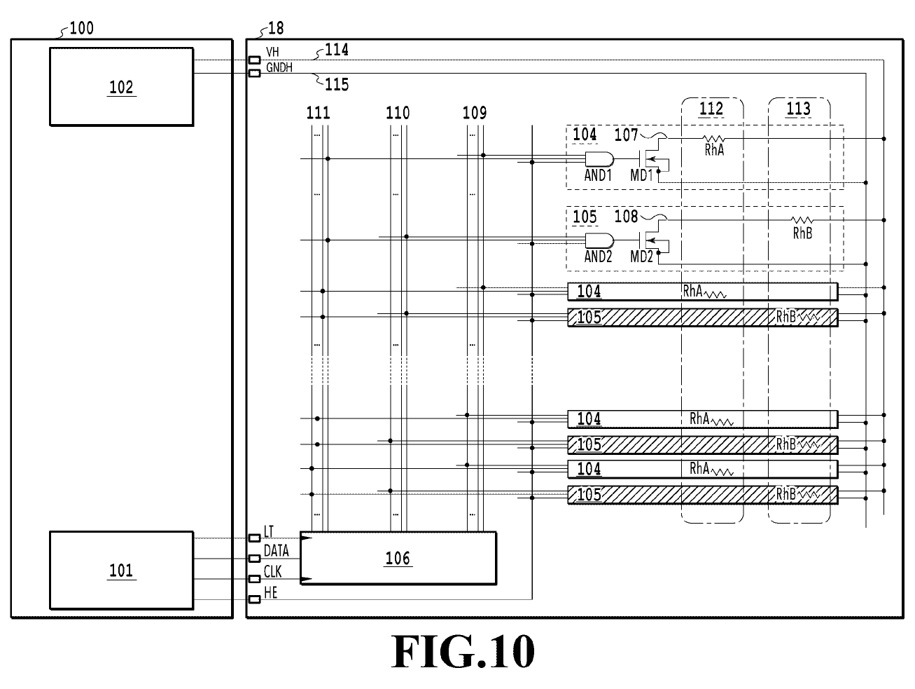

As described above, to suppress the effect of concentrated ink, it is preferable to return the ink to initial fresh ink as much as possible, whether it is high concentration ink or low concentration ink. Therefore, in the case of driving the second ejection heater RhB, the lower the effect of recirculation concentration, the more the circulation effect can be obtained. In other words, the configuration of the straight-type individual flow channel 23 can obtain the circulation effect more than that of the U-shaped one. Next, an electrical circuit configuration for controlling the driving of the first ejection heater RhA and the second ejection heater RhB according to this embodiment will be described using FIGS. 10-17 .
<Heater Selection Circuit>

FIG. 10 is a diagram showing an example of a circuit configuration of the recording element substrate 18 according to this embodiment. The recording element substrate 18 is supplied with various signals from a main PCB 100. The main PCB 100 includes a power supply circuit 102 and a controller 101. The power supply circuit 102 applies power supply voltage to the recording element substrate 18 via a power supply voltage wire VH. The power supply circuit 102 and the recording element substrate 18 are connected via a GNDH wire 115. The GNDH wire 115 is included in a ground wiring layer. The ground wiring layer sets a reference potential of the recording element substrate 18. Thus, the GNDH wire 115 functions as the reference potential of the recording element substrate 18. The controller 101 mainly includes a ROM, a RAM, and a CPU, and supplies various electrical signals to the recording element substrate 18. The controller 101 is connected to the recording element substrate 18 via an enable signal line HE, a latch signal line LT, a data signal line DATA, and a clock signal line CLK. The controller 101 supplies an enable signal via the enable signal line HE. The enable signal is a signal that controls the time to turn on a control target element and apply current thereto using a pulse width. The enable signal is a signal for making adjustment to allow generation of more desired thermal energy in consideration of the manufacturing variations of the heater resistance values in the recording element substrate 18, the manufacturing variations of the power supply circuit 102, and the voltage drop in the power supply wire when a plurality of heaters are driven simultaneously. This embodiment describes an example of sharing the enable signal line HE for ejection and circulation in order to reduce the number of signal terminals, but if it is provided separately for ejection and circulation, it is possible to use different pulse widths for ejection and circulation. Note that this embodiment assumes a case where the first ejection heater RhA and the second ejection heater RhB share the enable signal line HE, and assumes the following. In other words, the pulse width of the enable signal is preferably adjusted assuming that the first ejection heater RhA and the second ejection heater RhB are formed in the same process in the semiconductor manufacturing process and have the same manufacturing variations (the amount of deviation of the resistance value from the ideal value). The controller 101 supplies a latch signal to the recording element substrate 18 via the latch signal line LT. The controller 101 supplies a data signal to the recording element substrate 18 via the data signal line DATA. The controller 101 supplies a clock signal to the recording element substrate 18 via the clock signal line CLK.

The recording element substrate 18 includes a plurality of first ejection modules 104 and a plurality of second ejection modules 105. Each first ejection module 104 includes a first ejection heater RhA, a first ejection driving element MD1, and a first ejection logic circuit AND1. The first ejection heater RhA is also referred to as the first resistive heating element. The first ejection driving element MD1 (also referred to as the first driving element) is an element for applying current to the first ejection heater RhA. The first ejection logic circuit AND1 is an element for selectively driving the first ejection driving element MD1 included in a corresponding first ejection module 104 from among the plurality of first ejection modules 104. The recording element substrate 18 generates heat by applying current to the first ejection heater RhA. This foams and ejects ink. This allows recording on the ejection target medium P. Further, in this embodiment, the plurality of first ejection heaters RhA are arranged in a row to form a first ejection heater row 112.

Here, it is assumed that the first ejection driving element MD1 is composed of a MOSFET (Metal-Oxide-Semiconductor Field Effect Transistor). In an example in FIG. 10, the source terminal of the first ejection driving element MD1 is connected to the GNDH wire 115. Further, the gate terminal of the first ejection driving element MD1 is connected to the output side of the first ejection logic circuit AND1. Further, the drain terminal of the first ejection driving element MD1, the first ejection heater RhA, and the power supply voltage wire VH are connected to each other. The drain terminal of the first ejection driving element MD1 and the first ejection heater RhA are connected to each other via a first ejection drain wire 107. When gate drive voltage is applied between the gate terminal and the source terminal of the first ejection driving element MD1 according to the signal output from the first ejection logic circuit AND1, the following occurs. In other words, the drive current flows to the first ejection heater RhA via the first ejection drain wire 107. This causes the first ejection heater RhA to generate heat. Therefore, the ink is foamed and ejected to allow recording on the ejection target medium P. However, the first ejection driving element MD1 may be composed of something other than a MOSFET. For example, the first ejection driving element MD1 may be composed of a bipolar transistor. Alternatively, the first ejection driving element MD1 may be composed of an IGBT (Insulated Gate Bipolar Transistor).

Each second ejection module 105 includes a second ejection heater RhB, a second ejection driving element MD2, and a second ejection logic circuit AND2. The second ejection heater RhB is also referred to as the second resistive heating element. The second ejection driving element MD2 (also referred to as the second driving element) is an element for applying current to the second ejection heater RhB. The second ejection logic circuit AND2 is an element for selectively driving the second ejection driving element MD2 included in a corresponding second ejection module 105 from among the plurality of second ejection modules 105. The recording element substrate 18 generates heat by applying current to the second ejection heater RhB. This foams and ejects ink. This allows recording on the ejection target medium P. Further, in this embodiment, the plurality of second ejection heaters RhB are arranged in a row to form a second ejection heater row 113.

Here, it is assumed that the second ejection driving element MD2 is composed of a MOSFET (Metal-Oxide-Semiconductor Field Effect Transistor). In an example in FIG. 10, the source terminal of the second ejection driving element MD2 is connected to the GNDH wire 115. Further, the gate terminal of the second ejection driving element MD2 is connected to the output side of the second ejection logic circuit AND2. Further, the drain terminal of the second ejection driving element MD2, the second ejection heater RhB, and the power supply voltage wire VH are connected to each other. The drain terminal of the second ejection driving element MD2 and the second ejection heater RhB are connected to each other via a second ejection drain wire 108. When gate drive voltage is applied between the gate terminal and the source terminal of the second ejection driving element MD2 according to the signal output from the second ejection logic circuit AND2, the following occurs. In other words, the drive current flows to the second ejection heater RhB via the second ejection drain wire 108. This causes the second ejection heater RhB to generate heat. Thus, the bubble B of the ink grows, creating a circulatory flow, as described above. However, the second ejection driving element MD2 may be composed of something other than a MOSFET. For example, the second ejection driving element MD2 may be composed of a bipolar transistor. Alternatively, the second ejection driving element MD2 may be composed of an IGBT (Insulated Gate Bipolar Transistor).

Note that the first ejection heater RhA may use a piezo element as an element for ejecting ink. The second ejection heater RhB may use a piezo element as an element for circulating ink. At least one of the first ejection heater RhA and the second ejection heater RhB may be utilized as an element for heating a specific area in the recording element substrate 18. Alternatively, at least one of the first ejection heater RhA and the second ejection heater RhB may be utilized as a temperature detecting element for monitoring its own temperature.

It is assumed that the first ejection driving element MD1 and the second ejection driving element MD2 are N-type high-voltage MOSFETs. High-voltage MOSFETs are driving elements with a higher tolerable level compared to those used in logic circuits. This embodiment assumes that a high-voltage MOSFET is formed not to fail even if a large voltage (e.g., 32 V) is applied that cannot be tolerated by driving elements used in a general logic circuit that constitutes the controller 101.

The recording element substrate 18 includes a control data supply circuit 106. The recording element substrate 18 is provided with a first ejection group selection signal line 109, a second ejection group selection signal line 110, a time-division selection signal line 111, and the enable signal line HE. The control data supply circuit 106 is electrically connected to each of the first ejection group selection signal line 109, the second ejection group selection signal line 110, the time-division selection signal line 111, and the enable signal line HE. Each of the first ejection group selection signal line 109, the time-division selection signal line 111, and the enable signal line HE is electrically connected to the first ejection module 104. Each of the second ejection group selection signal line 110, the time-division selection signal line 111, and the enable signal line HE is electrically connected to the second ejection module 105. Thus, the control data supply circuit 106 can transmit and receive various signals to and from the first ejection module 104 via the first ejection group selection signal line 109 and the time-division selection signal line 111. Further, the control data supply circuit 106 can transmit and receive various signals to and from the second ejection module 105 via the second ejection group selection signal line 110 and the time-division selection signal line 111.

Specifically, each of the first ejection group selection signal line 109, the time-division selection signal line 111, and the enable signal line HE is connected to the input side of the first ejection logic circuit AND1. The output side of the first ejection logic circuit AND1 is connected to the gate terminal of the first ejection driving element MD1. Thus, according to the output of the first ejection logic circuit AND1, the first ejection driving element MD1 becomes conductive and is selectively controlled so that the current flows to the first ejection heater RhA. Further, each of the second ejection group selection signal line 110, the time-division selection signal line 111, and the enable signal line HE is connected to the input side of the second ejection logic circuit AND2. The output side of the second ejection logic circuit AND2 is connected to the gate terminal of the second ejection driving element MD2. Thus, according to the output of the second ejection logic circuit AND2, the second ejection driving element MD2 becomes conductive and is selectively controlled so that the current flows to the second ejection heater RhB.

In this embodiment, the time-division selection signal line 111 is shared by the first ejection module 104 and the second ejection module 105. Thus, the time-division selection signal line 111 may contribute to the reduction of the amount of serial data transfer and the reduction of the layout area for wiring of signal lines in the recording element substrate 18.

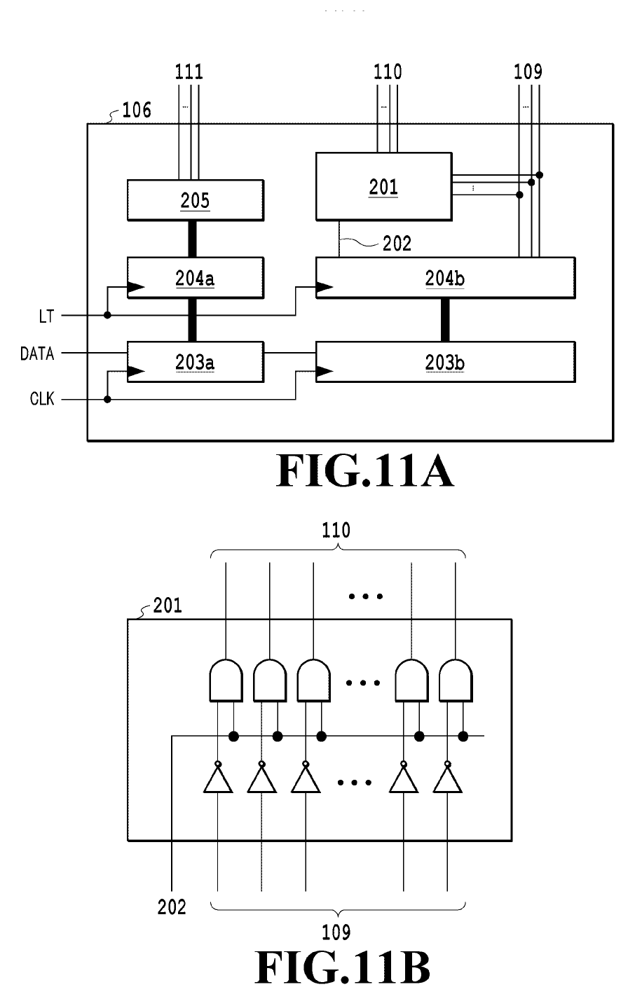

FIG. 11A is a functional block diagram of a circuit configuration of a control data supply circuit 106. FIG. 11B is a diagram showing an example of a circuit configuration of a second ejection group selection circuit 201 in FIG. 11A. The control data supply circuit 106 includes shift registers 203a and 203b, latch circuits 204a and 204b, a decoder circuit 205, and the second ejection group selection circuit 201. The control data supply circuit 106 is provided with external input terminals. The control data supply circuit 106 is supplied with a clock signal, a data signal, and a latch signal from the controller 101 via the external input terminals. The clock signal is a signal utilized in transferring, by serial data transfer, data signals to the shift registers 203a and 203b. The data signal includes selection information of a first ejection module 104 and selection information of a second ejection module 105. The latch signal is a signal for acquiring various types of information stored in each of the shift registers 203a and 203b for each latch period, and causing each of the latch circuits 204a and 204b to hold them.

The decoder circuit 205 is a circuit that expands q-bit input data to (2 to the power of q)-bit output data. Specifically, when 4-bit input data is input to the decoder circuit 205, the decoder circuit 205 converts the 4-bit input data into 16 (= 2 to the power of 4) bits of output data. At this time, the output data of the decoder circuit 205 is output as information in which only one bit out of 16 bits is enabled. This enables the time-division driving of each of the plurality of first ejection modules 104 and the plurality of second ejection modules 105 via the time-division selection signal line 111.

The second ejection group selection circuit 201 includes AND circuits and NOT circuits. A NOT circuit outputs a signal obtained by logically inverting a first ejection group selection signal obtained from the first ejection group selection signal line 109 (hereinafter referred to as a logically inverted signal). An AND circuit receives input of a logically inverted signal and a second flag signal via the second flag signal line 202. The second flag signal is included in a data signal that is serially transferred from the controller 101. The second flag signal functions as a flag for setting the second ejection group selection signal to be enabled and disabled, which is output via the second ejection group selection signal line 110. In other words, the second ejection group selection circuit 201 generates a second ejection group selection signal according to the selection information of the first ejection group selection signal and the second flag signal. Thus, when the first ejection module 104 is in the selected state, the second ejection module 105 is in the non-selected state. On the other hand, even when the first ejection module 104 is in the non-selected state, if the second flag signal is 0, the second ejection group selection signal is disabled, and the second ejection module 105 does not enter the selected state. In other words, if the first ejection module 104 is in the non-selected state and the second flag signal is 1, the second ejection group selection signal is enabled, and the second ejection module 105 enters the selected state. Note that while the time-division selection is not performed, neither the first ejection module 104 nor the second ejection module 105 is selected.

Since a driving element generally operates at a higher voltage than a logic circuit, a substrate in which high-voltage driving elements and normal driving elements coexist is used. This embodiment has described above that the first ejection driving element MD1 and the second ejection driving element MD2 are assumed to be high-voltage MOSFETs. More specifically, they are assumed to be composed of DMOSFETs (Double-diffused MOSFETs) as high-voltage MOSFETs. Logic circuits such as the first ejection logic circuit AND1, the second ejection logic circuit AND2, the second ejection group selection circuit 201, the shift registers 203a and 203b, the latch circuits 204a and 204b, and the decoder circuit 205 are assumed to be composed of low-voltage MOSFETs.

### First Case

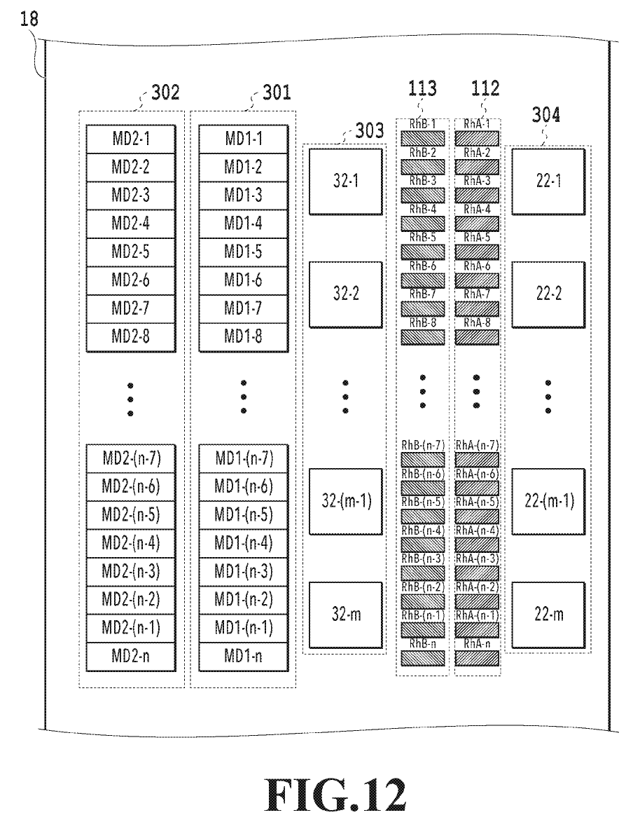

FIG. 12 is a diagram showing an example of arrangement of heaters and driving elements in a first case according to this embodiment. In FIG. 12, a plurality of first ejection heaters RhA-1 to RhA-n and a plurality of second ejection heaters RhB-1 to RhB-n are arranged on the recording element substrate 18 as heaters. The plurality of first ejection heaters RhA-1 to RhA-n are arranged in a row in the longer-side direction of the recording element substrate 18 to form the first ejection heater row 112. The plurality of second ejection heaters RhB-1 to RhB-n are arranged in a row in the longer-side direction of the recording element substrate 18 to form the second ejection heater row 113. Further, in FIG. 12, a plurality of first ejection driving elements MD1-1 to MD1-n and a plurality of second ejection driving elements MD2-1 to MD2-n are arranged on the recording element substrate 18 as driving elements. The plurality of first ejection driving elements MD1-1 to MD1-n are arranged in a row in the longer-side direction of the recording element substrate 18 to form a first ejection driving element row 301. The plurality of second ejection driving elements MD2-1 to MD2-n are arranged in a row in the longer-side direction of the recording element substrate 18 to form a second ejection driving element row 302.

Further, in FIG. 12, in addition to the first ejection heater row 112, the second ejection heater row 113, the first ejection driving element row 301 (also referred to as the first driving element row), and the second ejection driving element row 302 (also referred to as the second driving element row), the following are formed. In other words, supply port rows 303 and 304 are formed on the recording element substrate 18. The supply port row 303 is formed by a plurality of supply ports 32-1 to 32-m being arranged in a row in the longer-side direction of the recording element substrate 18. The supply port row 304 is formed by a plurality of supply ports 22-1 to 22-m being arranged in a row in the longer-side direction of the recording element substrate 18. In the first case, the first ejection heater row 112 is arranged on the left of the supply port row 304 in parallel. The second ejection heater row 113 is arranged on the left of the first ejection heater row 112 in parallel. The supply port row 303 is arranged on the left of the second ejection heater row 113 in parallel. The first ejection driving element row 301 is arranged on the left of the supply port row 303 in parallel. The second ejection driving element row 302 is arranged on the left of the first ejection driving element row 301 in parallel.

Further, in this embodiment, one supply port 22 and one supply port 32 are arranged every four first ejection heaters RhA and every four second ejection heaters RhB, respectively, but the arrangement is not limited to this. Further, the size of the supply ports 22 and the size of the supply ports 32 may be different. Further, the number of supply ports 22 and the number of supply ports 32 may not be the same.

Further, the first ejection heater row 112 is in a first arrangement relationship in which it is arranged in a region farther from the region where the first ejection driving element row 301 and the second ejection driving element row 302 are arranged than the second ejection heater row 113. Further, the first ejection driving element row 301 is in a second arrangement configuration in which it is arranged in a region closer to the first ejection heater row 112 and the second ejection heater row 113 than the second ejection driving element row 302. FIG. 12 shows an example in which the first ejection heater row 112, the second ejection heater row 113, the first ejection driving element row 301, and the second ejection driving element row 302 are arranged in this order based on the first and second arrangement relationships mentioned above.

In short, it is only required that the driving element on the side farther from the heaters is connected to the heater on the side closer to the driving elements, and the driving element on the side closer to the heaters is connected to the heater on the side farther from the driving elements. For example, it may be assumed that the second ejection heater row 113, the first ejection heater row 112, the second ejection driving element row 302, and the first ejection driving element row 301 are arranged in this order. In this assumption, the second ejection heater row 113 is in an arrangement relationship in which it is arranged in a region farther from the region where the first ejection driving element row 301 and the second ejection driving element row 302 are arranged than the first ejection heater row 112. Further, the second ejection driving element row 302 is in an arrangement relationship in which it is arranged in a region closer to the first ejection heater row 112 and the second ejection heater row 113 than the first ejection driving element row 301. Even under such an assumption, they are in a relationship in which the driving element on the side farther from the heaters is connected to the heater on the side closer to the driving elements, and the driving element on the side closer to the heaters is connected to the heater on the side farther from the driving elements.

Further, it is assumed that the respective resistance values of the first ejection heater RhA and the second ejection heater RhB are substantially the same. Further, it is assumed that the respective sizes of the first ejection heater RhA and the second ejection heater RhB are the same size.

Note that the resistive heating element region is a region where the resistive heating elements are arranged on the same layer in the recording element substrate 18. In this embodiment, at least one of the first ejection heater RhA and the second ejection heater RhB is used as a resistive heating element. Thus, the resistive heating element region is a region in which at least one of the first ejection heater RhA and the second ejection heater RhB is disposed in the recording element substrate 18. For example, the region including the first ejection heater row 112 and the second ejection heater row 113 on the same layer in the recording element substrate 18 is the resistive heating element region. Specifically, the plurality of first ejection heaters RhA formed as the first ejection heater row 112 are arranged in a first region in the resistive heating element region. Further, the plurality of second ejection heaters RhB formed as the second ejection heater row 113 are arranged in a second region in the resistive heating element region. Note that when other resistive heating elements are arranged, it is sufficient that the other resistive heating elements are arranged in a third region in the resistive heating element region.

Further, the element size of the first ejection driving element MD1 is substantially the same as the element size of the second ejection driving element MD2. For example, it is assumed that the size of the first ejection driving element MD1 and the size of the second ejection driving element MD2 are the same size. Under this assumption, the resistance value (on-resistance value) when the first ejection heater RhA is driven is the same as the resistance value (on-resistance value) when the second ejection heater RhB is driven.

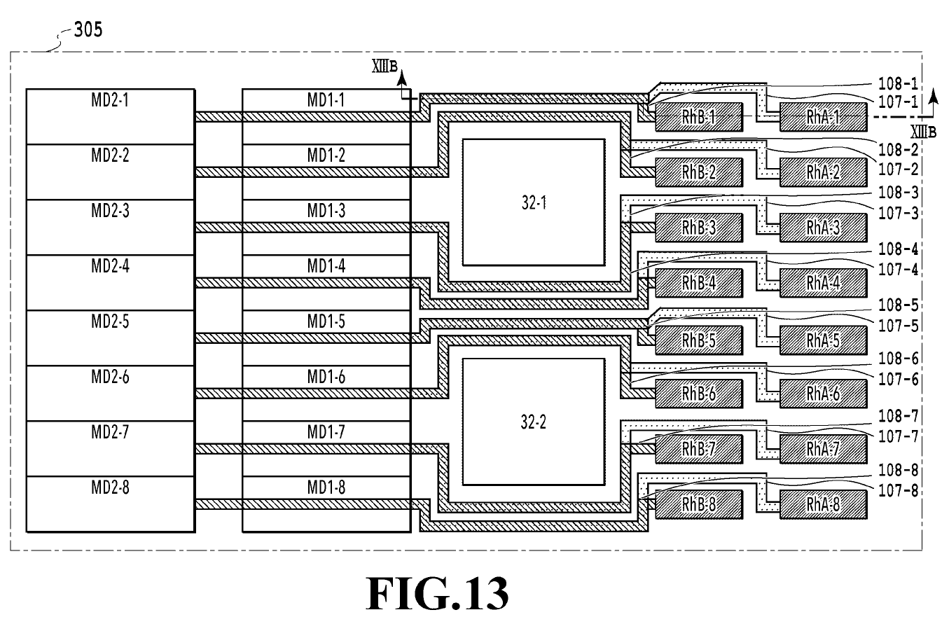

FIG. 13 is a partially enlarged view of an example of arrangement of heaters and driving elements in the first case in FIG. 12. In FIG. 13, first ejection drain wires 107-1 to 107-8 and second ejection drain wires 108-1 to 108-8 are laid out as constituent elements of a unit 305 formed on the recording element substrate 18. This means that the unit 305 includes the first ejection drain wires 107-1 to 107-8 and the second ejection drain wires 108-1 to 108-8. In addition, the unit 305 further includes the supply ports 32-1 and 32-2, the first ejection driving elements MD1-1 to MD1-8, the second ejection driving elements MD2-1 to MD 2-8, the first ejection heaters RhA-1 to RhA-8, and the second ejection heaters RhB-1 to RhB-8.

Specifically, the second ejection drain wires 108-1 to 108-4 pass by the supply port 32-1 to connect the second ejection heaters RhB-1 to RhB-4 to the second ejection driving elements MD2-1 to MD2-4. The second ejection drain wires 108-5 to 108-8 pass by the supply port 32-2 to connect the second ejection heaters RhB-5 to RhB-8 to the second ejection driving element MD2-5 to MD2-8.

The first ejection drain wires 107-1 to 107-4 pass by the supply port 32-1 to be connected to the first ejection driving elements MD1-1 to MD1-4. The first ejection drain wires 107-5 to 107-8 pass by the supply port 32-2 to be connected to the first ejection driving elements MD1-5 to MD1-8.

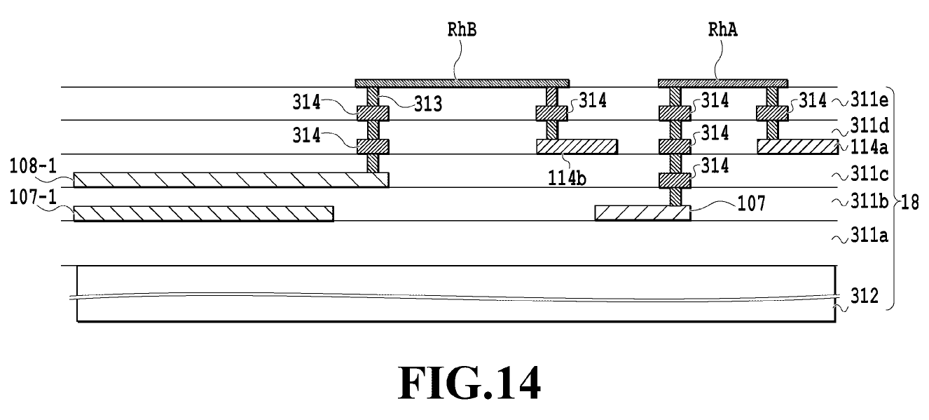

In short, some of the first ejection drain wires 107 and the second ejection drain wires 108 are laid out to pass through the region between the supply ports 32. Note that although this embodiment lays out, for one supply port 32, four first ejection drain wires 107 and four second ejection drain wires 108 passing by the supply port 32, the number of laid-out wires is not limited to four. Further, although FIG. 13 shows an example in which the wire width of the first ejection drain wires 107 and the wire width of the second ejection drain wires 108 are the same, the wire widths are not limited to them. The wire width of the first ejection drain wires 107 may be different from the wire width of the second ejection drain wires 108. Next, a layer configuration of the recording element substrate 18 will be described using FIG. 14.

FIG. 14 is a diagram showing a cross-sectional structure taken along the XIIIB-XIIIB line in FIG. 13. The recording element substrate 18 can be manufactured using known semiconductor manufacturing processes. For example, the recording element substrate 18 includes a substrate 312 and a plurality of electrical elements. The substrate 312 is composed of a semiconductor such as monocrystalline silicon. The plurality of electrical elements are provided on the substrate 312.
Insulative Layer 311

Specifically, an insulative layer 311 is formed on the substrate 312. For example, an inorganic material such as silicon oxide is used for the insulative layer 311. The insulative layer 311 has the function of electrical isolation. For example, in this embodiment, the insulative layer 311 electrically isolates the first ejection heater RhA and the second ejection heater RhB. Further, although not shown in FIG. 14, the insulative layer 311 electrically isolates the first ejection driving element MD1 and the second ejection driving element MD2.

In this embodiment, the insulative layer 311 includes insulative layers 311a, 311b, 311c, 311d, and 311e. A wiring layer including the first ejection drain wire 107-1 is formed in the insulative layer 311b. Respective wiring layers including the first ejection drain wires 107-2 to 107-8 are also formed in the insulation layer 311b. A wiring layer including the second ejection drain wire 108-1 is formed in the insulative layer 311c. Respective wiring layers including the second ejection drain wires 108-2 to 108-8 are also formed in the insulation layer 311c. In other words, the second ejection drain wire 108 (also referred to as the second wire) is formed in a layer different from that of the first ejection drain wire 107 (also referred to as the first wire). In this embodiment, the layer in which the second ejection drain wire 108 is formed is located above the layer in which the first ejection drain wire 107 is formed. Further, the power supply voltage wires VH 114a and VH 114b are formed in the insulative layer 311d.
Connecting Member 313

A via that penetrates the insulative layers 311b to 311e is provided with a connecting member 313. In FIG. 14, connecting members 313 are also provided to vias penetrating the insulative layers 311d to 311e and a via penetrating the insulative layers 311c to 311e. The connecting members 313 are formed in an electrically connectable state by providing a contact plug inside these vias. A connecting member 313 is provided for electrically connecting a conductive layer 314, electrical elements in upper layers, electrical elements in lower layers, electrical elements in the layer between the upper and lower layers, and the like. The electrical elements also include electrode layers of the first ejection driving element MD1 and the second ejection driving element MD2. Here, the upper layers collectively refer to layers that are in the direction away from the substrate 312 when a certain layer is used as a reference. The lower layers collectively refer to layers that are in the direction toward the substrate 312 when a certain layer is used as a reference. For example, assuming that the reference layer is the insulative layer 311d, the upper layers correspond to, for example, the insulative layer 311e, and the lower layers correspond to, for example, the insulative layers 311c, 311b, and 311a. Note that in this embodiment, a conductive layer 314 is provided in each of the insulative layers 311c, 311d, and 311e. This allows electrical connection with the electrical elements included in each of the insulative layers 311b, 311c, 311d, and 311e through the connecting member 313 and the conductive layers 314.

In FIG. 14, the first ejection heater RhA and the second ejection heater RhB are arranged on the upper surface of the insulative layer 311e, which is the top layer of the insulative layers 311. In other words, the first ejection heater RhA is placed on the same layer as the second ejection heater RhB. Further, in FIG. 14, a part of the first ejection heater RhA can be electrically connected to the first ejection drain wire 107-1 via the connecting member 313 and the conductive layers 314. Further, a part of the second ejection heater RhB can be electrically connected to the second ejection drain wire 108-1 via the connecting member 313 and the conductive layers 314. The other part of the first ejection heater RhA can be electrically connected to the power supply voltage wire VH 114a via the connecting member 313 and the conductive layer 314. The other part of the second ejection heater RhB can be electrically connected to the power supply voltage wire VH 114b via the connecting member 313 and the conductive layer 314. Although the power supply voltage wire VH 114a and the power supply voltage wire VH 114b are connected in common in this embodiment, they may be configured to be separately connected and separately supplied with power supply voltage.

Note that although this embodiment assumes that the common wiring layer of the GNDH wire 115 in FIG. 10 is arranged in an upper layer above the power supply voltage wire VH 114 in FIG. 14, the present disclosure is not limited to this. The GNDH wire 115 in FIG. 10 may be in a lower layer than the power supply voltage wire VH 114. Alternatively, the GNDH wire 115 in FIG. 10 may be in the same layer as the power supply voltage wire VH 114. Further, the common wiring layer of the GNDH wire 115 is arranged in the largest possible region in the region included in the recording element substrate 18. This enables the total resistance value of the resistance value of each first ejection heater RhA and the resistance value of the GNDH wire to be substantially the same as the total resistance value of the resistance value of each second ejection heater RhB and the resistance value of the GNDH wire.

Further, the electrode layer of the first ejection driving elements MD1-1 to MD1-8 in FIG. 13 and the electrode layer of the second ejection driving elements MD2-1 to MD2-8 in FIG. 13 are formed in the same layer as the first ejection drain wire 107. In other words, the second ejection driving element row 302 is arranged in the same layer as the first ejection driving element row 301 in parallel. The electrode layer of the first ejection driving elements MD1-1 to MD1-8 in FIG. 13 includes the drain electrodes, source electrodes, and gate electrodes of the first ejection driving elements MD1-1 to MD1-8 in FIG. 13. The electrode layer of the second ejection driving elements MD2-1 to MD2-8 in FIG. 13 includes the drain electrodes, source electrodes, and gate electrodes of the second ejection driving elements MD2-1 to MD2-8 in FIG. 13. Further, the electrode layer of the first ejection driving element MD1 is connected to the first ejection drain wire 107. The electrode layer of the second ejection driving element MD2 is connected to the second ejection drain wire 108. From the above description, the second ejection drain wire 108 and the first ejection drain wire 107 are in different layers. Further, the electrode layer of the second ejection driving element MD2 is formed in the same layer as the first ejection drain wire 107. Thus, the second ejection drain wire 108 and the electrode layer of the second ejection driving element MD2 are in different layers. For this reason, the electrode layer of the second ejection driving element MD2 can be electrically connected to the second ejection drain wire 108 through a connecting member 313 and a conductive layer 314 in the same layer as the second ejection drain wires 108. In other words, the wiring layer in which the second ejection drain wire 108 is formed is a layer different from the electrode layer of the second ejection driving element MD2, and an electrical interlayer connection is made between that wiring layer and the electrode layer of the second ejection driving element MD2 through a via. Note that from the above description, the wiring layer in which the first ejection drain wire 107 is formed is formed in the same layer as the electrode layer of the first ejection driving element MD1 and the electrode layer of the second ejection driving element MD2.

Further, the first ejection heater RhA and the second ejection heater RhB may be made of a metal with relatively large electrical resistance, such as silicon tantalum nitride and silicon tungsten nitride. Although not shown in FIG. 14, it is assumed that the first ejection driving element MD1 and the second ejection driving element MD2 are provided in the same semiconductor layer, and both are composed of an N-type MOSFET as described above. Further, the connecting member 313, the conductive layer 314, the first ejection drain wire 107-1, the second ejection drain wire 108-1, and the power supply voltage wire VH 114 are made of a metal with relatively small electrical resistance. For example, the connecting member 313 is made of tungsten, copper, or the like. Further, for example, the conductive layer 314, the first ejection drain wire 107-1, the second ejection drain wire 108-1, and the power supply voltage wire VH 114 are made of aluminum, copper, or the like. Further, in this embodiment, the first ejection drain wire 107-1 and the second ejection drain wire 108-1 are formed in layers different from each other, and thus are laid out in a total of two layers. Further, the second ejection drain wire 108-1 is formed in an upper layer compared to the first ejection drain wire 107-1.

Further, although a part of the first ejection drain wire 107-1 and a part of the second ejection drain wire 108-1 appear to have an overlapping portion in FIG. 13, this is an example of the same wire width, and they are formed in layers different from each other as shown in FIG. 14.

Further, it is assumed that the first ejection drain wire 107 and the second ejection drain wire 108 are the same in material and thickness. It is assumed that the respective wire widths and wire lengths of the first ejection drain wire 107 and the second ejection drain wire 108 are adjusted so that the respective wire resistance values of the first ejection drain wire 107 and the second ejection drain wire 108 are substantially the same.

Note that it is desirable that the first ejection drain wire 107 and the second ejection drain wire 108 are the same in material and thickness, but the present disclosure is not limited to this. For example, when the first ejection drain wire 107 and the second ejection drain wire 108 are different in material and thickness, the respective wire widths and wire lengths of the first ejection drain wire 107 and the second ejection drain wire 108 are adjusted. By this adjustment, the respective wire resistance values of the first ejection drain wire 107 and the second ejection drain wire 108 may be uniformized as much as possible.

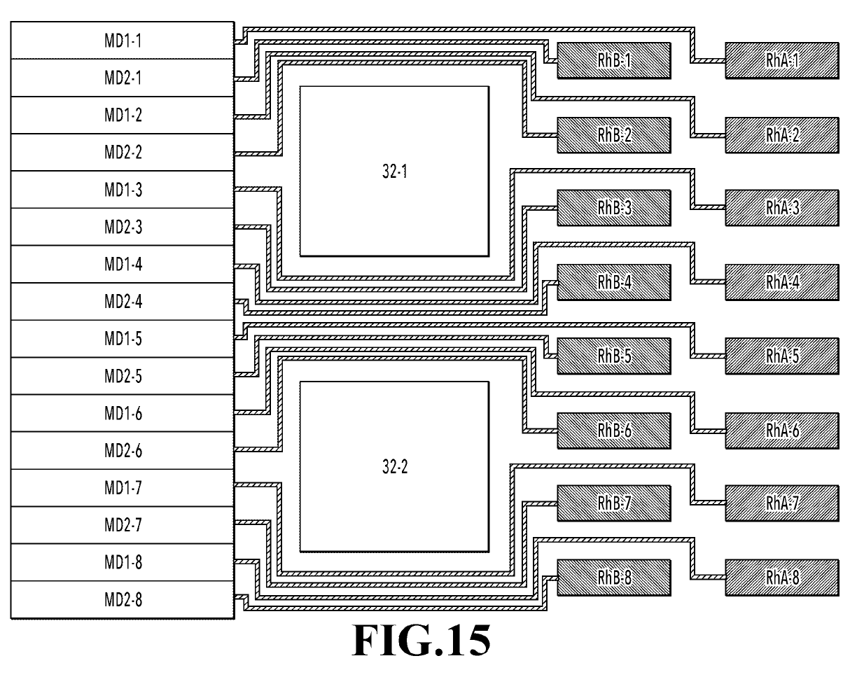

Further, although the respective electrical elements of the conductive layer 314, the first ejection drain wire 107-1, the second ejection drain wire 108-1, and the power supply voltage wire VH 114 are formed in layers different from each other and thus are composed of a total of four layers in this embodiment, the present disclosure is not limited to this. They may be composed of a different number of layers than this embodiment. Next, a comparative example will be described using FIG. 15.

### Comparative Arrangement Example

FIG. 15 is a diagram showing a comparative example of arrangement of heaters and driving elements. In FIG. 15, it is assumed that ejection drain wires and circulation drain wires are laid out in the same layer. Thus, the region for passing the ejection drain wires and the circulation drain wires cannot be sufficiently secured between the supply port 32-1 and the supply port 32-2. Therefore, in the comparative arrangement example in FIG. 15, the respective wire widths of the ejection drain wires and the circulation drain wires are thinner than intended. Further, the first ejection driving elements MD1 and the second ejection driving elements MD2 are alternately arranged in a single row. Thus, it is not possible to secure sufficient space for placing the first ejection driving elements MD1 and the second ejection driving elements MD2. Therefore, in the comparative arrangement example in FIG. 15, the sizes of the first ejection driving elements MD1 and the second ejection driving elements MD2 are smaller than intended.

### Effects of First Case

From the above description, in the first case, the first ejection drain wires 107 and the second ejection drain wires 108 are laid out in different layers, which are a total of two layers. Thus, the first ejection drain wires 107 and the second ejection drain wires 108 are not laid out in the same layer, and one drain wire is laid out in one layer. Therefore, the region through which wires can be passed between the supply ports 32 is doubled. This allows securing sufficient space for laying out the drain wires in each layer. Therefore, it is possible to secure the wire width of the drain wires as intended. For this reason, driving elements such as the first ejection driving elements MD1 and the second ejection driving elements MD2 can be appropriately arranged on the recording element substrate 18.

Further, in the longer-side direction of the recording element substrate 18, the first ejection driving element row 301 and the second ejection driving element row 302 are arranged in two rows. This doubles the region where driving elements can be laid out. Thus, it is possible to set the size of the driving elements as intended.

Further, the driving element on the side farther from the heaters is connected to the heater on the side closer to the driving elements, and the driving element on the side closer to the heaters is connected to the heater on the side farther from the driving elements.

For example, it is assumed that the first ejection heater row 112, the second ejection heater row 113, the first ejection driving element row 301, and the second ejection driving element row 302 are arranged in this order. In this assumption, the first ejection heater row 112 is in an arrangement relationship in which it is arranged in a region farther from the region where the first ejection driving element row 301 and the second ejection driving element row 302 are arranged than the second ejection heater row 113. Further, the first ejection driving element row 301 is in an arrangement configuration in which it is arranged in a region closer to the first ejection heater row 112 and the second ejection heater row 113 than the second ejection driving element row 302. Under such an assumption, the following applies. In other words, the second ejection driving element MD2 on the side farther from the heaters is connected to the second ejection heater RhB on the side closer to the driving elements by the second ejection drain wire 108. Further, the first ejection driving element MD1 on the side closer to the heater is connected to the first ejection heater RhA on the side farther from the driving element by the first ejection drain wire 107.

Alternatively, for example, it is assumed that the second ejection heater row 113, the first ejection heater row 112, the second ejection driving element row 302, and the first ejection driving element row 301 are arranged in this order. In this assumption, the second ejection heater row 113 is in an arrangement relationship in which it is arranged in a region farther from the region where the first ejection driving element row 301 and the second ejection driving element row 302 are arranged than the first ejection heater row 112. Further, the second ejection driving element row 302 is in an arrangement relationship in which it is arranged in a region closer to the first ejection heater row 112 and the second ejection heater row 113 than the first ejection driving element row 301. Under such an assumption, it is as follows. In other words, the first ejection driving element MD1 on the side farther from the heaters is connected to the first ejection heater RhA on the side closer to the driving elements by the first ejection drain wire 107. Further, the second ejection driving element MD2 on the side closer to the heaters is connected to the second ejection heater RhB on the side farther from the driving elements by the second ejection drain wire 108.

Such a configuration makes it easier to uniformize the respective wire lengths of the first ejection drain wire 107 and the second ejection drain wire 108. Thus, it is easy to equalize the respective wire resistance values of the first ejection drain wire 107 and the second ejection drain wire 108. Therefore, it is possible to equalize the respective energy losses (hereinafter referred to as voltage drops) that occur in the first ejection drain wire 107 and the second ejection drain wire 108.

Here, when the first ejection heater RhA and the second ejection heater RhB are driven, voltage drops that occur in portions other than the first ejection heater RhA and the second ejection heater RhB are as follows. In other words, except for to the respective wire resistance values of the first ejection drain wire 107 and the second ejection drain wire 108, the following are included. In other words, voltage drops are included that are caused by the respective on-resistances of the first ejection driving element MD1 and the second ejection driving element MD2 and the total resistance values of the GNDH wires 115.

In the first case, it is assumed that the respective on-resistance values of the first ejection driving element MD1 and the second ejection driving element MD2 are substantially the same, and the total resistance values of the GNDH wires 115 are also substantially the same. Thus, when the first ejection heater RhA and the second ejection heater RhB are driven, the voltage drops that occur in portions other than the first ejection heater RhA and the second ejection heater RhB are the same. Therefore, each of the first ejection heater RhA and the second ejection heater RhB can perform stable heater driving with small variations.

Further, when the respective on-resistance values of the first ejection driving element MD1 and the second ejection driving element MD2 and the total resistance values of the GNDH wires 115 are different, it suffices to take the following measure. In other words, by adjusting the respective wire widths or wire lengths of the first ejection drain wire 107 and the second ejection drain wire 108, the total wire resistance values other than the first ejection heater RhA and the second ejection heater RhB may be uniformized as much as possible.

### Second Case

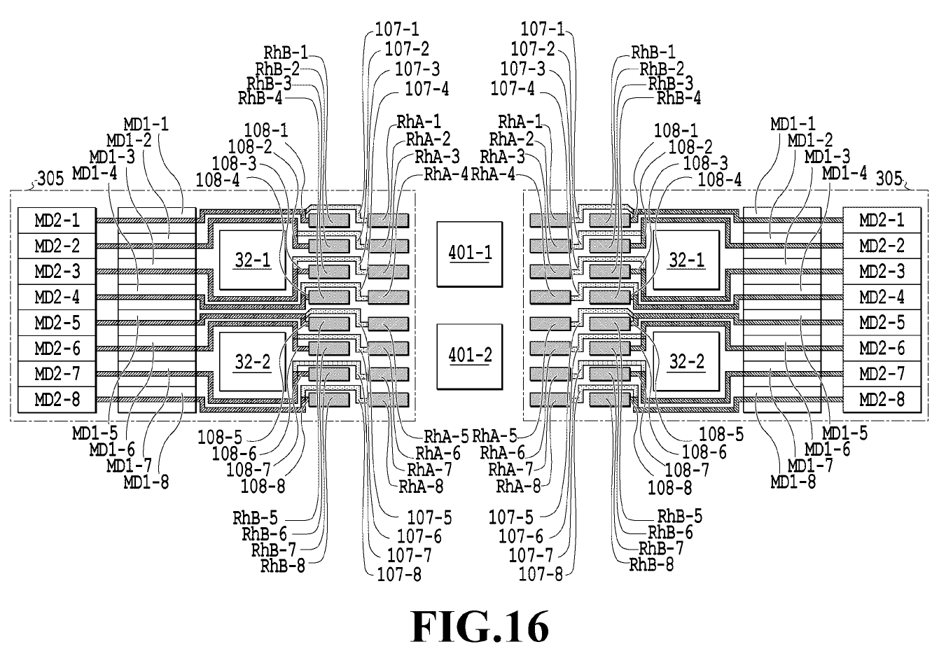

FIG. 16 is an example of arrangement of heaters and driving elements in a second case according to this embodiment. The second case is different from the first case in that a plurality of units 305 are provided. The second case is a layout in which the units 305 are arranged symmetrically with respect to the longer-side direction of the recording element substrate 18. Further, the second case is a layout in which supply ports 401-1 and 401-2 are provided between the units 305. In such a layout, the supply ports 401-1 and 401-2 have the function of supplying ink to the units 305. Thus, the size of the recording element substrate 18 can be reduced.

Specifically, a unit 305 includes a first ejection driving element row, a second ejection driving element row, and a resistive heating element region. The first ejection driving element row includes the first ejection driving elements MD1-1 to MD1-8. The second ejection driving element row includes the second ejection driving elements MD2-1 to MD2-8. The resistive heating element region includes the first ejection heaters RhA-1 to RhA-8 and the second ejection heaters RhB-1 to RhB-8. In this embodiment, two units 305 are formed. The units 305 are arranged symmetrically with respect to the supply ports 401 so that the resistive heating element regions face each other. In such an arrangement configuration, the units 305 are placed on both sides of the supply ports 401. Thus, the supply ports 401 can supply ink to the units 305. Therefore, it is possible to reduce the size of the entire recording element substrate 18.

Note that the size of the supply ports 401-1 and 401-2 may be the same as or different from the size of the supply ports 32-1 and 32-2. Further, although the second case shows an example in which the number of supply ports 401 is the same as the number of supply ports 32, the number of supply ports 401 may be different from the number of supply ports 32. Further, although an example is shown in which eight first ejection heaters RhA are arranged for one supply port 401, the number is not limited to eight. The same applies to the second ejection heaters RhB. Further, although an example of two units 305 is shown, the number may be three or more. In other words, in the second case, at least two units 305 are formed.

### Third Case

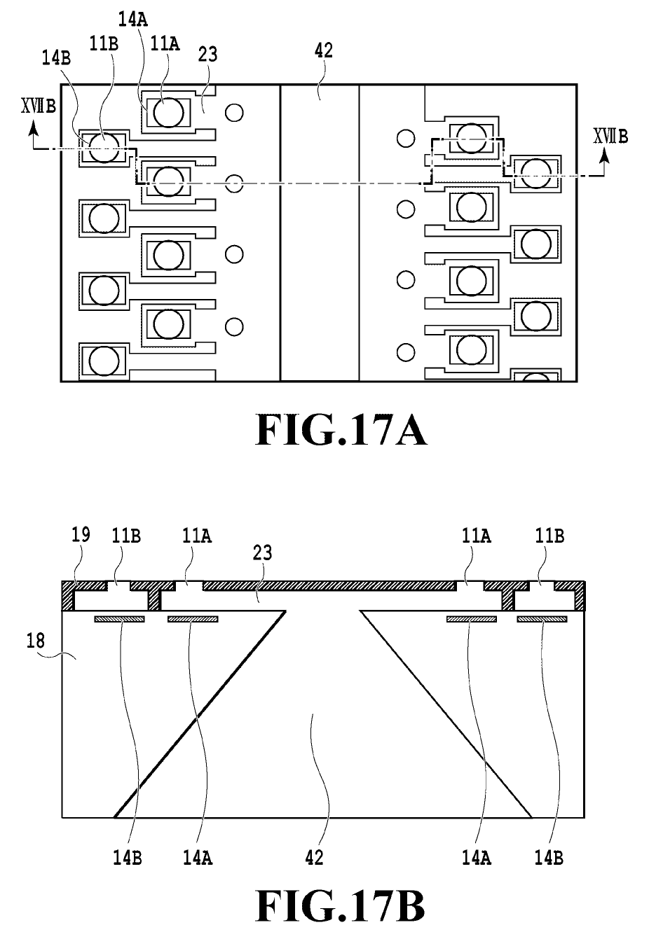

A third case is a case in which a first ejection heater 14A and a second ejection heater 14B are placed on both sides of the supply groove 42, and there is no configuration for circulating ink such as the external pump 71. The first ejection heater 14A has the same configuration and function as the first ejection heater RhA. The second ejection heater 14B has the same configuration and function as the second ejection heater RhB. FIG. 17A is a plan view seen from the direction in which droplets are ejected from ejection ports 11A and 11B. FIG. 17B is a cross-sectional view taken along the XVIIB-XBIIB line in FIG. 17A. The ejection ports 11A and 11B are formed on the orifice plate 19. the first ejection heater RhA and the second ejection heater RhB are formed directly below the ejection ports 11A and 11B. The individual flow channel 23 is supplied with liquid from the supply groove 42. Even in such a case, the drain wires laid out in two layers connect the first ejection heater 14A to the first ejection driving element MD1 and connect the second ejection heater 14B to the second ejection driving element MD2 as in the first case. Thus, it is possible to have the same effects as in the first case.

### Other Exemplary Embodiments

Although the first to third cases in this embodiment have been described above, the present invention is not limited to the above-mentioned values, forms, and numbers, and they shall be varied according to the configuration of the recording element substrate 18. For example, the number of nozzles per nozzle row is not limited to 8 or 16. For example, the number of nozzles per nozzle row may be 512. Further, the nozzle rows themselves may be not only one or two rows, but also three or more multiple rows.

Although the various examples and embodiments of the present disclosure have been shown and described above, the purpose and scope of the present disclosure are not limited to the specific description of the present specification. The present disclosure is not limited to the embodiments described above, and various modifications may be made. Further, in the present disclosure, the above embodiments may be partially combined as appropriate.

### Modification 1

For example, although this embodiment has described an example of using vias for electrical connection with other wiring layers, it is not limited to this. For example, instead of vias that cause electrical conduction between some wiring layers and other wiring layers among a plurality of stacked wiring layers, electrically conductive coating may be applied to through-holes that penetrate all the wiring layers.

### Modification 2

Further, for example, the number of ejection ports per ejection port row in which a plurality of ejection ports 11 are arranged in a row is not limited. It may be 8, 16, or 512. The number of ejection port rows is also not limited. It may be one, two, or three or more.

### Modification 3

Further, for example, either one of the first ejection heater RhA and the second ejection heater RhB may function as a circulation heater for circulating ink. For example, in the case of a configuration in which there is no ejection port 11 directly above the second ejection heater RhB as shown in FIG. 4, it is possible to assign the function of circulating ink to the second ejection heater RhB.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a 'non-transitory computer-readable storage medium') to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

According to the present disclosure, it is possible to properly arrange driving elements on a recording element substrate.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2025-071748, filed Apr. 23, 2025, which is hereby incorporated by reference herein in its entirety.

What is claimed is:

1. A recording element substrate comprising:
a resistive heating element region including a first resistive heating element row including a plurality of first resistive heating elements being arranged in a row and a second resistive heating element row including a plurality of second resistive heating elements being arranged in a row, the second resistive heating element row being parallel to the first resistive heating element row;
a driving element region including a first driving element row including a plurality of first driving elements for driving the plurality of first resistive heating elements, the plurality of first driving elements being arranged in a row, and a second driving element row including a plurality of second driving elements being arranged in a row, the second driving element row being parallel to the first driving element row, the driving element region being located in parallel to the resistive heating element region;
a first wiring layer connecting farther one of the first driving element row and the second driving element row from the resistive heating element region and closer one of the first resistive heating element row and the second resistive heating element row from the driving element region; and
a second wiring layer connecting closer one of the first driving element row and the second driving element row from the resistive heating element region and farther one of the first resistive heating element row and the second resistive heating element row from the driving element region,
wherein the first wiring layer is formed in a layer different from the second wiring layer.

2. The recording element substrate according to claim 1, wherein the first resistive heating element row, the second resistive heating element row, the first driving element row, and the second driving element row are arranged in a direction orthogonal to a row direction of the first resistive heating element row in order of the first resistive heating element row, the second resistive heating element row, the first driving element row, and the second driving element row.

3. The recording element substrate according to claim 1, wherein respective resistance values of the plurality of first resistive heating elements and the plurality of second resistive heating elements are substantially equal.

4. The recording element substrate according to claim 1, wherein a plurality of supply ports for supplying liquid are arranged in a row along a row direction of the first resistive heating element row between the resistive heating element region and the driving element region.

5. The recording element substrate according to claim 4, wherein a plurality of first wires included in the first wiring layer and a plurality of second wires included in the second wiring layer are arranged between the plurality of supply ports.

6. The recording element substrate according to claim 1, wherein the first wiring layer is formed in an upper layer above the second wiring layer.

7. The recording element substrate according to claim 1, wherein a resistance value of the first wiring layer is substantially equal to a resistance value of the second wiring layer.

8. The recording element substrate according to claim 1, wherein the second wiring layer is a layer different from an electrode layer of the second driving elements, and an electrical interlayer connection is made between the second wiring layer and the electrode layer of the plurality of second driving elements through a via.

9. The recording element substrate according to claim 4, wherein one of the first resistive heating element row and the second resistive heating element row generates heat for ejecting liquid supplied from the plurality of supply ports.

10. The recording element substrate according to claim 4, wherein one of the first resistive heating element row and the second resistive heating element row generates heat for circulating liquid supplied from the plurality of supply ports.

11. The recording element substrate according to claim 1, wherein an element area of the first driving elements is substantially equal to an element area of the second driving elements.

12. The recording element substrate according to claim 1, wherein driving current to the first resistive heating element supplied from the first driving element is substantially equal to drive current to the second resistive heating element supplied from the second driving element.

13. The recording element substrate according to claim 1, wherein drive current to the first resistive heating element is substantially equal to drive current to the second resistive heating element.

14. The recording element substrate according to claim 1, wherein the first wiring layer is formed in the same layer as an electrode layer of the first driving elements and an electrode layer of the second driving elements.

15. The recording element substrate according to claim 1, further comprising:
a second supply port for supplying ink; and
at least one unit including the driving element region and the resistive heating element region, wherein
the at least one unit comprises at least two units, and the at least two units are formed, and
the at least two units are arranged symmetrically with respect to the second supply port so that the respective resistive heating element regions face each other.

16. The recording element substrate according to claim 1, further comprising a power supply wire configured to be electrically connected for supplying power to each of the plurality of first resistive heating elements and the plurality of second resistive heating elements.

17. The recording element substrate according to claim 1, further comprising a ground wire configured to be electrically connected for setting a reference potential to each of the plurality of first driving elements and the plurality of second driving elements.
